(19) United States
(12) Patent Application Publication
(10) Pub. No.: US 2006/0153977 A1
(43) Pub. Date: Jul. 13, 2006

(54) Magnetic tape, and manufacturing method and winding apparatus therefor

(75) Inventor: Kyouhisa Uchiumi, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/287,357

(22) Filed: Nov. 28, 2005

(30) Foreign Application Priority Data
Jan. 12, 2005 (JP) 2005-004672
Jan. 12, 2005 (JP) 2005-004675
Jan. 17, 2005 (JP) 2005-009165
Jan. 17, 2005 (JP) 2005-009168

(51) Int. Cl. G11B 5/85; B65H 18/28

(52) U.S. Cl. 427/130; 242/525

(57) ABSTRACT

The present invention relates to a magnetic tape, a magnetic tape manufacturing method, and a magnetic tape winding apparatus; and the magnetic tape manufacturing method is the method for the magnetic tape curved in a width direction, and comprises a determination process of determining a curvature polarity possessed in advance by the magnetic tape, and a winding process of winding the magnetic tape on a first taper hub comprising a taper winding face corresponding to the curvature polarity of the magnetic tape.

### CROSS REFERENCE TO RELATED APPLICATIONS

This application claims the foreign priority benefit under Title 35, United States Code, § 119 (a)-(d), of Japanese Patent Application Nos. 2005-004672, 2005-004675, 2005-009165 and 2005-009168, filed in the Japan Patent Office, the disclosure of which is herein incorporated by reference in its entirety.

### BACKGROUND OF THE INVENTION

1. Field of the Invention

The present invention relates to a magnetic tape, a manufacturing method and a winding apparatus therefor, and particularly, to the magnetic tape, the manufacturing method and the winding apparatus therefor (hereinafter principally referred to as “magnetic tape manufacturing method” and “magnetic tape winding apparatus,” respectively) that prevent irregularity (winding irregularity) of a wound form of the tape wound on a tape reel.

2. Description of the Related Art

Recently a magnetic tape is made a high recording density, accompanied with an increase of a memory capacity, and layer thinning and smoothing thereof are proceeding. Particularly, in a magnetic tape for a data backup a recording capacity of the magnetic tape becomes a larger capacity, accompanied with that of a computer. Therefore, in the magnetic tape it is necessary to increase the recording capacity, and then a track pitch has to be made smaller.

Generally, as an external recording medium for a data backup of such a computer is widely used, for example, a magnetic tape of a linear or helical system of 2.65 mm in width. Although the magnetic tape is handled in a state of being wound on a tape reel, positions of end faces of tape edges are apt to become irregular (so called winding irregularity) in winding the magnetic tape on the tape in a winding apparatus or a drive. Specifically, in a high speed winding a remarkable winding irregularity occurs in many cases. Such the winding irregularity is apt to give edge damage during transportation, gives a bad winding tendency during storage, thereby a tape travel accuracy within a drive is degraded, and thus the winding irregularity becomes a cause of a servo tracking abnormality. Therefore, in assuring a requested performance of a commercial product, it is important to manufacture a magnetic tape that ensures a good wound form in shipping and where a winding irregularity is difficult to occur within a drive.

Conventionally, it is known that: if giving a magnetic tape a winding tendency of a predetermined curvature form, a good wound form is ensured; a tape travel is stabilized; and a performance of servo tracking is improved.

In Japanese Patent Laid-Open Publication Nos. 2004-164808 and 2004-280920 is described a technology for giving a winding tendency of a curvature form by winding a magnetic tape on a reel hub (hereinafter referred to as “taper hub”) having a taper winding face, and by keeping at a predetermined temperature (not more than a glass transition temperature). According to this, a winding tendency is apt to be firmly fixed and it is enabled to always ensure a good wound form.

In addition, in a magnetic tape winding apparatus (tape winder) or a drive in manufacturing the magnetic tape, when winding the tape on a tape reel with a flange, it is also enabled to eliminate a winding irregularity. Particularly, because when winding the magnetic tape at high speed, the winding irregularity is apt to occur, it is preferable to use a winding irregularity prevention mechanism.

In order to solve such the winding irregularity of a magnetic tape, a magnetic tape winding apparatus is disclosed that prevents the winding irregularity of the tape from occurring by providing a magnet at a flange of a tape reel, attracting the tape to a side of the flange, where the magnet is disposed, and thus winding the tape (for example, see Japanese Patent Laid-Open Publication No. Hei. 1-313238).

In addition, in winding a magnetic tape on a reel hub (hereinafter simply referred to as “hub”) with a flange is disclosed a cosmetic winding apparatus of the tape for improving a wound form by making a cosmetic winding tissue intervene between a flange of a tape reel and a side face of the tape (for example, see Japanese Patent Laid-Open Publication No. 2004-146037).

In addition, a treatment method for improving a wound form of a magnetic tape is disclosed that when making the tape curve and wound, it is designed that the tape nears one flange side and is wound by being wound on a winding face of a taper hub, kept at a predetermined temperature, and heat-treated (for example, see Japanese Patent Laid-Open Publication Nos. 2004-164808 and 2004-280920).

However, in the technology in the Japanese Patent Laid-Open Publication Nos. 2004-164808 and 2004-280920, although a desired curvature form is obtained at an inner perimeter side of a pancake near the taper hub, there is a problem that: at an outer perimeter side thereof its curvature polarity becomes a opposite direction to that of the inner perimeter side; a magnetic tape does not curve (curvature amount Q=0 (mm/m)) from a middle perimeter across the outer perimeter; and the desired curvature form cannot be obtained. This is because a direction of the taper hub is not made to correspond to a curvature polarity of the magnetic tape although there exists a variation in the curvature polarity possessed in advance by the tape before wound.

The magnetic tape winding apparatus in the Japanese Patent Laid-Open Publication No. Hei. 1-313238 dose not generate an irregularity in a wound form and is effective in a case that a thickness of a magnetic layer of the magnetic tape is thicker. However, in a current newest magnetic tape, a thicknesses of a magnetic layer and its total thickness are thinner, not more than 0.3 μm and 10 μm, respectively; a recording density is higher; and a magnetic tape by servo tracking is a main stream in order to improve the recoding density and the track density. With respect to such the magnetic tape of an ultra thin magnetic layer, in the magnetic tape winding apparatus of the Japanese Patent Laid-Open Publication No. 2004-164808, there is a problem that a prevention effect of a winding irregularity cannot be desired and the winding apparatus cannot be used if a force of the tape applied in a reverse direction is larger than magnetism of a magnet, even if the tape is attracted by the magnet in the act of being wound.

In addition, although the cosmetic winding apparatus of a magnetic tape in the Japanese Patent Laid-Open Publication No. 2004-146037 intends to prevent the winding irregularity of the tape by making the cosmetic winding tissue intervene between the flange of the tape reel and the side face of the c tape and by regulating so that the tape nears one side of the flange, there is a problem that a friction resistance becomes larger if the regulation for nearing the one side in a width direction is made stronger in order to improve a wound form.

Furthermore, in a case that a winding speed of the magnetic tape is made higher, there is a problem that edge damage occurs.

In addition, in the treatment method for improving the wound form of a magnetic tape in the Japanese Patent Laid-Open Publication Nos. 2004-164808 and 2004-280920, although it is possible to make the tape near one side of the flange and to wind the tape by enlarging the curvature amount of the tape curvedly formed, there is a problem that a minute projection phenomenon of one to several wraps cannot be suppressed.

Furthermore, in the Japanese Patent Laid-Open Publication Nos. 2004-164808 and 2004-280920, although a regular winding effect becomes larger by enlarging the curvature amount of the magnetic tape, if running the tape for a long time, its edge is damaged by strongly contacting the flange, and due to this, fine dust occurs. Therefore, in a magnetic tape formed in a larger curvature, there is a problem that a servo error and a drop out increase due to the dust.

Then if the servo error increases, there is a problem that it is not enabled to read data recorded in the magnetic tape.

Consequently, it is strongly requested to provide a magnetic tape; a magnetic tape manufacturing method, and a magnetic tape winding apparatus that can suppress a variation in a production process, obtain a constant curvature form also at an outer perimeter of a pancake and a good wound form of the tape.

### SUMMARY OF THE INVENTION

An aspect of a manufacturing method for a magnetic tape in the present invention is the method for the magnetic tape curved in a width direction, and comprises a determination process of determining a curvature polarity possessed in advance by the tape, and a winding process of winding the tape on a first taper hub comprising a taper winding face corresponding to the curvature polarity of the tape.

In accordance with the manufacturing method, determining the curvature polarity possessed in advance by the magnetic tape, a desired curvature form is given to, not to mention to an inner perimeter side, but also to an outer perimeter.

The manufacturing method may also be designed to further comprise, in advance of the determination process, a bulk roll placement process of placing a bulk roll at a supply reel side of a winding apparatus, and a slitting process of slitting magnetic tape whole cloth sent out from the bulk roll into a plurality of predetermined width tapes, wherein the winding process places the taper hub at a take-up reel side of the winding apparatus in a direction corresponding to the curvature polarity of the magnetic tape and wind the magnetic tape, which is sent out from the bulk roll and is slit, on the taper hub.

Thus winding the magnetic tape on the taper hub corresponding to the curvature polarity of the tape, a desired curvature form is given to, not to mention the inner perimeter side, but also to the outer perimeter side in the tape wound on the taper hub. In other words, it is enabled to align a curvature polarity given to total tape length and to suppress a variation. Meanwhile, the direction corresponding to the curvature polarity is a direction where the curvature polarity (direction) given by the taper hub and the curvature polarity (direction) of the magnetic tape match.

The manufacturing method may also be designed to further comprise, in advance of the determination process, a bulk roll placement process of placing a bulk roll at a supply reel side of a winding apparatus, and a slitting process of slitting magnetic tape whole cloth sent out from the bulk roll into a plurality of predetermined width tapes, wherein the determination process determines the curvature polarity of the magnetic tape, based on a form of the bulk roll. Here, the bulk roll is a hub where whole cloth of a wide magnetic tape is wound, and the curvature polarity of the magnetic tape is correlated with the form of the bulk roll.

In addition, the manufacturing method may also be designed to further comprise, in advance of the winding process, a process of winding the magnetic tape, which is sent out from the bulk roll and is slit, on a hub comprising a flat winding face. In other words, after winding the magnetic tape made from the bulk roll on the hub comprising the flat winding face, the tape is wound on a taper hub corresponding to the curvature polarity of each magnetic tape in the winding process. Firstly, winding the magnetic tape on the hub comprising the flat winding face, a pancake is made. In the winding process, because it suffices to only wind the pancake by a winding apparatus corresponding to each polarity, there is no burdensome work such as aligning a direction of the taper hub, and thereby the process is simplified.

In addition, in the manufacturing method the determination process may also be designed to measure the form of the bulk roll and determine the curvature polarity of each magnetic tape slit from a slit position, which makes it a standard a width direction end of the bulk roll, and a taper amount of the outer perimeter of the bulk roll at the slit position. Because the taper amount of the outer perimeter of the bulk roll is correlated with the curvature polarity of the each slit magnetic tape, thus the curvature polarity of the tape is determined.

In addition, in the manufacturing method the determination process may also be designed to measure a curvature amount in a width direction between two arbitrary points in a longitudinal direction of the magnetic tape and to determine the curvature polarity of the tape. Practically measuring the curvature polarity of the magnetic tape, the curvature polarity is determined.

In addition, in the manufacturing method the determination process may also be designed to comprise a rewinding process of rewinding a magnetic tape, which is determined as having either one of a plus or minus curvature polarity, on a taper hub corresponding to an opposite polarity after the winding process. Rewinding the magnetic tape on the taper hub corresponding to another polarity after the winding process, a second pancake having an opposite polarity is made.

In addition, the manufacturing method may also be designed to comprise a heat treatment process of keeping the magnetic tape wound in the winding process for a predetermined time under a predetermined environment temperature and heat-treating the tape; and alternatively, a heat treatment process of keeping the tape rewound in the rewinding process for a predetermined time under a predetermined environment temperature and heat-treating the tape. Thus, by heat-treating a pancake obtained, because the magnetic tape is stress-relieved according to the taper form of the taper hub, a desired curvature form is given to the tape.

In addition, in the manufacturing method the taper hub may also be designed to comprise a fit-in hole for engaging in a rotation engagement stopper pin provided at a winding shaft for rotating the taper hub, and the fit-in hole may open to only one side face. Thus designed, because the fit-in hole of the taper hub opens to only one side face, the rotation engagement stopper pin interferes and cannot fit in the winding shaft from a side where the fit-in hole of the taper hub is not formed. Therefore, it is enabled to prevent an attachment mistake of mistaking the direction of the taper hub and attaching it.

Another aspect of a magnetic tape manufacturing method in the present invention is the method for winding the magnetic tape, which is obtained by being slit from a bulk roll, on a taper hub having a taper winding face, the method comprising: a bulk roll placement process of placing the bulk roll at a supply reel side of a winding apparatus; a determination process of determining a plus curvature polarity and a minus curvature polarity possessed in advance by the tape; a hub placement process of placing the taper hub at a take-up reel side of the winding apparatus in a direction corresponding to either one of the plus or minus curvature polarity; and a winding process of winding a magnetic tape sent out from the bulk roll on the taper hub, wherein when in the bulk roll placement process the taper hub is placed in the direction corresponding to the curvature polarity of the tape according to a determination result in the determination process, the tape wound on the taper hub in the winding process is kept for a predetermined time under a predetermined environment temperature and is heat-treated, and wherein when in the bulk roll placement process the taper hub is placed in the direction not corresponding to the curvature polarity of the tape according to a determination result in the determination process, the tape is rewound on a taper hub corresponding to the curvature polarity of the tape, then is kept for a predetermined time under a predetermined environment temperature, and is heat-treated.

In the manufacturing method, after the bulk roll is placed at the supply reel side, the curvature polarity possessed in advance by the magnetic tape is determined. Then the taper hub is placed at the take-up reel side in the direction corresponding to either one of the plus or minus curvature polarity of the magnetic tape (hub placement process), and the magnetic tape sent out from the bulk roll is wound on the taper hub. Then in the hub placement process, when the taper hub is placed in the direction corresponding to the curvature polarity of the magnetic tape, the magnetic tape wound on the taper hub in the winding process is kept for a predetermined time under a predetermined environment temperature and is heat-treated, and when the taper hub is placed in the direction not corresponding to the curvature polarity of the magnetic tape according to a determination result in the determination process, the magnetic tape is rewound on the taper hub corresponding to the curvature polarity of the magnetic tape, then is kept for a predetermined time under a predetermined environment temperature, and is heat-treated. Thus winding each magnetic tape on a taper hub corresponding to the curvature polarity of the tape and heat-treating it, a desired curvature form is given to, not to mention an inner perimeter but also to an outer perimeter in the tape wound on the taper hub. In other words, the curvature polarity given to total length of the magnetic tape is aligned, and a variation thereof is suppressed. Meanwhile, the direction corresponding to the curvature polarity is a direction where the curvature polarity (direction) given by the taper hub and the curvature polarity (direction) of the magnetic tape match.

In accordance with such the magnetic tape manufacturing method, because the magnetic tape is wound on a taper hub corresponding to a curvature polarity possessed in advanced by the magnetic tape and a pancake is made, it is enabled to prevent a variation of an outer perimeter side due to a mismatch of a taper direction of the taper hub for the magnetic tape and to give a stable curvature form also to the outer perimeter side. Thus, because it is enabled to provide a magnetic tape where a good curvature form is obtained and to ensure a wound form of the tape, it is enabled to obtain stability in tape travel. In addition, it is enabled to reduce cost thanks to an improvement of a yield ratio of the magnetic tape.

Another aspect of the present invention provides a magnetic tape manufactured by the manufacturing method, wherein the tape has a curvature amount of 0.5 to 4.0 mm/m; in addition, the aspect provides a magnetic tape manufactured by the manufacturing method, wherein the tape has a curvature amount of −4.0 to −0.5 mm/m. Thus the present invention can provide the magnetic tapes having the good curvature forms.

Still another aspect of a magnetic tape winding method of the present invention is, in winding a magnetic tape curved in an edge direction, the method for disposing a magnet adjacent to a flange of a tape reel and winding the tape, and further disposing the magnet at a shorter edge side of the curved magnetic tape and winding it (reel up process).

Meanwhile, the shorter edge is an inside edge of the curved magnetic tape.

Another aspect of a magnetic tape winding method of the present invention may also be, in winding a magnetic tape curved in an edge direction, the method for disposing a magnet adjacent to a flange of a tape reel and winding the tape, and further disposing the curved magnetic tape so that a shorter edge becomes at a side of the magnet and winding the tape.

Still another aspect of a magnetic tape winding apparatus of the present invention is, in winding a magnetic tape curved in an edge direction, the apparatus that comprises a magnet disposed adjacent to a flange of a tape reel and winds the tape, wherein the magnet is disposed at a shorter edge side of the tape.

In accordance with the magnetic tape winding method and winding apparatus, the magnetic tape is formed in a state of curved in an edge direction. Thus, because the magnetic tape is wound in a state of a tension at the shorter edge side being higher in being wound on a tape reel, it is wound so that the shorter edge side nears the flange of the tape reel.

Furthermore, in the magnetic tape winding apparatus the magnet is disposed at the shorter edge side, and thereby, because the magnet attracts the magnetic tape by magnetism, the tape is wound in a state of the shorter edge side nearing the flange of the tape reel.

In other words, the magnetic tape results in being attracted by an appropriate force and wound so that the shorter edge side always nears the flange of the tape reel by elasticity due to the curvature of the magnetic tape and by magnetism of the magnet.

Then because even in a case that a magnetic tape of which a thickness of a magnetic layer is ultra thin and which slightly curves is rotated and wound at high speed, the tape is wound so as to near the flange at the shorter edge side of the tape, it is accurately wound on the tape reel in a state of being stable.

Therefore, for example, even if a magnetic tape is 0.1 μm in thickness of a magnetic layer thereof, it is enabled to prevent a minute projection phenomenon, a servo error, and a drop out.

It may also be designed in the magnetic tape winding method that the magnetic tape is wound and heat-treated on the taper hub so that the curvature polarity becomes either one of the plus or minus direction, and after then, is wound on the tape reel. Meanwhile, the curvature polarity means a direction where the magnetic tape curves in a width direction of the tape. For example, it is assumed that: a state of the magnetic tape curving upward is a plus direction curvature (plus polarity); and a state of the magnetic tape curving downward is a minus direction curvature (minus polarity). In accordance with the magnetic tape manufacturing method a curved form is given to the magnetic tape so that the curvature polarity becomes either one of the plus or minus direction by being wound and heat-treated on a hub of which a winding face is a taper. After then, because the magnetic tape is wound in a state of a tension at the shorter edge side being always higher by being wound on the tape reel, it is wound so as to near the flange at the shorter edge side.

Meanwhile, it is preferable that the magnet consists of a neodymium magnet or an electromagnet that can generate strong magnetism and is larger in diameter than a wound roll of the magnetic tape.

Thus designed, the magnet results in being able to more effectively attract the magnetic tape to a flange of a side where the magnet is disposed and to make the tape wound on the tape reel.

In addition, a distance from the magnet to the wound roll of the magnetic tape is preferably 0.5 to 10.0 mm. Thus designed, the magnet results in being able to more effectively attract the magnetic tape to the flange of the side where the magnet is disposed and to make the tape wound on the tape reel. Meanwhile, the nearer the distance is, the higher the effect is.

In accordance with a specific aspect of the magnetic tape winding apparatus and magnetic tape manufacturing method of the present invention, even if the curvature amount of a magnetic tape is small, the curved magnetic tape can always be wound in a constant wound form, not generating a winding irregularity, and accurately be wound by being wound while attracted by a magnet disposed at a shorter edge side.

Therefore, for example, even if the magnetic tape is thinner in thickness of its magnetic layer, is larger in memory capacity, and is many in track number because it is enabled to prevent a minute projection phenomenon, it becomes enabled to prevent a servo error and a drop out.

Still another aspect of a magnetic tape winding apparatus of the present invention is the winding apparatus for winding a magnetic tape curved in an edge direction on a tape reel with a flange, wherein a cosmetic winding tissue is disposed on an inside face of the flange at a longer edge side of the curved magnetic tape.

Still another aspect of a magnetic tape winding method of the present invention is the method for winding a magnetic tape curved in an edge direction on a tape reel with a flange, wherein a cosmetic winding tissue is disposed on an inside face of the flange at a longer edge side of the curved magnetic tape (reel up process).

In accordance with the magnetic tape winding method the magnetic tape is formed in a state of being curved in the edge direction. Thus, because the curved magnetic tape is wound in a state of a tension at its shorter edge side being higher when wound on the tape reel, it is wound so that the shorter edge side nears the flange of the tape reel.

In addition, because the curved magnetic tape is regulated so as to near the opposite flange side to the cosmetic winding tissue by the tissue being disposed at the longer edge side of the tape, it is wound in a state of the shorter edge side being neared to the flange of the tape reel.

In other words, the magnetic tape results in being wound so that the shorter edge side always nears the adjacent flange by elasticity (winding tendency) due to the curvature of the tape and by regulation of the cosmetic winding tissue.

Then because even in a case that the magnetic tape of which a thickness of a magnetic layer is ultra thin and which slightly curves is rotated and wound at high speed, the tape is wound so as to near the flange at the shorter edge side of the tape by elasticity (winding tendency) due to the curvature of the tape and by regulation of the cosmetic winding tissue, it is accurately wound on the tape reel in a state of being stable.

Therefore, for example, even if the magnetic tape is not more than 0.3 μm in thickness of a magnetic layer and not more than 10 μm in total thickness thereof, it becomes enabled to prevent a minute projection phenomenon, a servo error, and a drop out.

The magnetic tape winding method may also be designed so that the cosmetic winding tissue is slantingly disposed with respect to a winding direction of the magnetic tape. The cosmetic winding tissue slants with respect to the winding direction of the magnetic tape, and thereby, results in being also slantingly disposed with respect to the flange of the tape reel. Therefore, the cosmetic winding tissue is disposed on the tape reel so that an entry width of the magnetic tape wound on the tape reel becomes wider. Thus, when the magnetic tape is wound on the tape reel, it becomes easy for the tape to smoothly enter within the flange and be wound, a friction between the flange and the cosmetic winding tissue is reduced, and thereby an occurrence of dust can be reduced. In addition, the cosmetic winding tissue slants, thereby the magnetic tape is pushed and regulated to the flange of the shorter edge side at a side adjacent to the tape in the cosmetic winding tissue, and thus the tape can always accurately be wound in a wound form of a more stable state. When sending out the magnetic tape from the tape reel, it becomes easy to send out the tape and to be able to run the tape in a more stable state.

In the magnetic tape winding method the magnetic tape may also be designed so as to be wound and heat-treated on a hub of which a winding face is a taper so that a curvature polarity becomes either one of a plus or minus direction, and after then, to be wound on the taper reel. Meanwhile, it is assumed that: a state of the magnetic tape curving upward is a plus direction curvature (plus polarity); and a state of the tape curving downward is a minus direction curvature (minus polarity). Thus, because the magnetic tape is wound in a state of a tension at the shorter edge side being always higher, it is wound so as to near the flange at the shorter edge side.

Meanwhile, the cosmetic winding tissue is preferably composed of non-woven cloth or cloth of an ultra fine fiber not more than 10 μm in diameter thereof.

Thus composed, the cosmetic winding tissue can remove fine dust which a magnetic tape generates by friction with a tape reel, a flange, and the like.

In addition, a diameter of the cosmetic winding tissue is preferably formed larger than that of a wound roll when a magnetic tape is wound on a tape reel.

Thus formed, the cosmetic winding tissue can buffer the magnetic tape to strongly contact the flange of the tape reel and be damaged.

Furthermore, a position where the cosmetic winding tissue regulates a magnetic tape wound on a tape reel is preferably 0.01 to 0.3 mm separate from an edge of the tape.

Thus separate, a regulation force and friction force of the flange and the cosmetic winding tissue become appropriate when the magnetic tape is wound on the tape reel, and thereby the cosmetic winding tissue can reduce the generation of dust.

In accordance with the magnetic tape manufacturing method and magnetic tape winding method of the present invention, the cosmetic winding tissue is disposed at the flange of the tape reel at the longer edge side of the curved magnetic tape, thereby a position where the tape is wound can be regulate by the cosmetic winding tissue. Thus even if the magnetic tape is the tape of a small curvature amount, it results in being always accurately wound in a constant wound form without generating a winding irregularity.

As a result, for example, even if a magnetic tape is thinner in thickness of its magnetic layer, is larger in memory capacity, and is many in track number because it is enabled to prevent a minute projection phenomenon, it becomes enabled to prevent a servo error and a drop out, and edge damage during transportation and to further reduce cost thanks to an improvement of a yield ratio.

### BRIEF DESCRIPTION OF THE DRAWINGS

FIG. 1 is a general flowchart showing a manufacturing process of a magnetic tape related to the present invention.

FIG. 2 is a process chart exemplifying a series of flow until a magnetic tape is wound on a tape reel.

FIG. 3A is a front view of a taper hub; FIG. 3B is a section view in an arrow direction of FIG. 3A.

FIG. 4 is a plan view of a pancake.

FIGS. 5A, 5B, and 5C are drawings illustrating a method for determining a curvature polarity of a magnetic tape; FIG. 5A is a front view of a bulk roll; FIG. 5B is a form measurement result of the bulk roll; and FIG. 5C is an illustration drawing of a polarity determination according to the measurement result of FIG. 5B.

FIGS. 6A and 6B are illustration drawings of a pancake winding process, a rewinding process, and a heat treatment process related to a first embodiment; FIG. 6A is a winding process of a magnetic tape having a plus polarity; and FIG. 6B is a winding process of a magnetic tape having a minus polarity.

FIGS. 7A and 7B are illustration drawings of a pancake winding process, a rewinding process, and a heat treatment process related to a second embodiment; FIG. 7A is a winding process of a magnetic tape having a plus polarity; and FIG. 7B is a winding process of a magnetic tape having a minus polarity.

FIG. 8 is a flowchart of a control unit related to a third embodiment.

FIG. 9A is a front view of a taper hub; FIG. 9B is a section view in an arrow direction of FIG. 9A; FIG. 9C is a front view of a winding shaft; and FIG. 9D is a section view in an arrow direction of FIG. 9C.

FIG. 10 is a process chart exemplifying a series of flow until a magnetic tape is wound on a tape reel.

FIGS. 11A and 11B are illustration drawings of pancake winding processes, a rewinding process, and heat treatment processes related to a third embodiment; FIG. 11A is a winding process of a magnetic tape having a plus polarity; and FIG. 11B is a winding process of a magnetic tape having a minus polarity.

FIGS. 12A and 12B are illustration drawings of a pancake winding process, a rewinding process, and a heat treatment process related to a fourth embodiment; FIG. 12A is a winding process of a magnetic tape having a plus polarity; and FIG. 12B is a winding process of a magnetic tape having a minus polarity.

FIGS. 13A and 13B are graphs showing a curvature amount at each point of a magnetic tape length measured from a taper hub side; FIG. 13A is a graph showing a curvature amount in a case that a selection is performed; and FIG. 13B is a graph showing a curvature amount in a case that the selection is not performed.

FIGS. 14A and 14B are plan views of magnetic tapes having curvature forms, respectively.

FIG. 15 is a general drawing showing a magnetic tape winding apparatus related to a sixth embodiment.

FIG. 16 is an illustration drawing showing a curvature amount of a magnetic tape.

FIG. 17 is a general drawing showing a variation example of a magnetic tape winding apparatus related to the sixth embodiment.

FIG. 18 is a general drawing showing an placement state of a cosmetic winding tissue in a magnetic tape winding apparatus related to a seventh embodiment.

FIG. 19 is an enlarged drawing of a substantial part showing an placement state of a cosmetic winding tissue in a magnetic tape winding apparatus related to the seventh embodiment.

FIG. 20A is a general drawing of a magnetic tape to be wound; FIG. 20B is a general drawing showing a state of the cosmetic winding tissue being disposed at a shorter edge side of the magnetic tape, and the tape being wound.

FIG. 21 is a general drawing showing a variation example of the magnetic tape winding apparatus related to the seventh embodiment.

### DESCRIPTION OF THE PREFERRED EMBODIMENTS

Here will be described exemplified embodiments of the present invention in detail, referring to drawings as needed.

Meanwhile, in drawings a bulk roll BR, a pancake PC, and a magnetic tape MT are illustrated, exaggerating forms of a curvature portion and taper portion thereof in order to show the portions.

[Magnetic Tape]

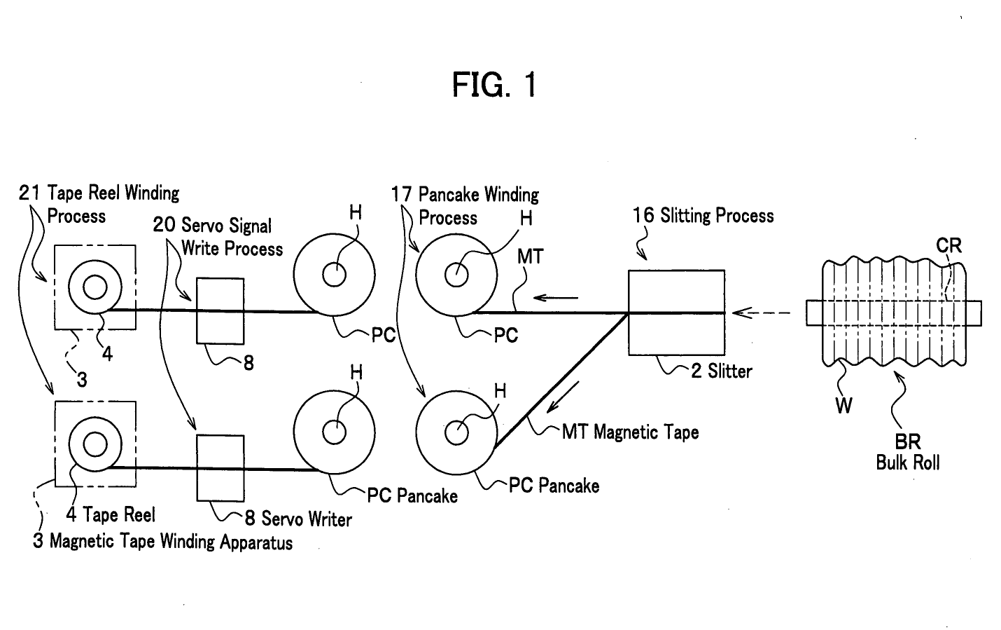

The magnetic tape MT shown in FIG. 1 is, for example, a tape used as a computer memory medium, and is mainly formed of a non-magnetic base film and a magnetic layer not shown. In the magnetic tape MT, as described later, a magnetic tape whole cloth W wound in a barrel form is slit into a predetermined tape width by a slitter 2, a winding tendency curved in a width direction is given to the pancake PC wound so that a curvature polarity thereof becomes either one of a plus or minus direction by heat treatment and the like, and after then, via a servo signal write process 20, the pancake PC is wound on a tape reel 4 by a magnetic tape winding apparatus 3.

<Magnetic Tape Whole Cloth>

The magnetic tape whole cloth W (bulk roll BR) is made, forming a magnetic layer on a base film. For example, the base film is a wide film not more than 10 μm in total thickness composed of polyethylene terephthalate (PET), polyethylene naphthalate (PEN), aramid, and the like. Meanwhile, in the base film it is preferable to use a polyester group excellent in workability and mechanical property and low in cost. In addition, it is more preferable to use polyethylene naphthalate (PEN) of which a strength, rigidity, and heat resistance are higher than those of polyethylene terephthalate (PET). The magnetic layer is formed by coating a magnetic paint, where a magnetic powder is dispersed in a solvent, on one face of the base film. The magnetic paint is generally adjusted by mixing the magnetic paint, a bond, and an organic solvent until the magnetic powder is uniformly dispersed. Or the magnetic layer is formed by depositing a ferromagnetic material such as metal, alloy, and the like on the base film by means of such as a vacuum deposition, sputtering, and the like. A thickness of the vacuum deposition is designed to be not more than 0.5 μm to cope with high density in recent years. In addition, depending on a product of a magnetic tape, a back coat layer is also coated on the other face of the base film. As shown in FIG. 1, winding such the magnetic tape whole cloth W on a winding core CR, the bulk roll BR is made. A surface of the bulk roll BR results in being corrugated due to a nonuniform coating of the magnetic paint. In other words, the thickness of the magnetic layer on the base film is nonuniform in width direction thereof.

[Magnetic Tape Manufacturing Method]

Next will be described a manufacturing method (process) of the magnetic tape MT, referring to FIG. 1.

As shown in FIG. 1, the manufacturing process of the magnetic tape MT until the bulk roll BR formed from the base film and the magnetic layer is wound on the tape reel 4 of a component of a magnetic tape cartridge (not shown) by a predetermined amount is as follows.

[Coating Process, Orientation Process, Drying Process, Calendar Treatment Process, and Bulk Roll Winding Process]

Firstly a wound base film is rewound, then in a bulk roll winding process (not shown) on the winding core CR is wound the wide magnetic tape whole cloth W manufactured via a coating process, an orientation process, a drying process, and a calendar treatment process not shown, and the bulk roll BR is made. In the course above, by coating a magnetic paint, where a magnetic powder is dispersed in a solvent, on one face of the base film, and in addition, depending on the product, by coating a back coat layer on the other face the base film, a surface of the bulk roll BR results in being corrugated due to a nonuniform coating of the magnetic paint. The bulk roll BR is, as shown in FIG. 1, placed at a supply reel of the slitter 2.

[Slitting Process]

Next, in a slitting process 16, by the slitter 2 is slit the magnetic tape whole cloth W into a tape width specified by a specification of a product (magnetic tape cartridge) into which the magnetic tape whole cloth W is finally manufactured. The magnetic tape MT thus manufactured results in a form with a thickness variation at each point in a width direction of the bulk roll BR due to the form of the bulk roll BR and a thickness caused by nonuniform coating.

Each magnetic tape MT slit into a predetermined tape width in the slitting process 16 is wound on each hub H in a pancake winding process 17 and is made the pancake PC. The magnetic tape MT wound into the pancake PC is different in a curvature polarity, depending on which position of the bulk roll BR the tape MT is originally located at, because there exists a thickness variation in the form of the bulk roll BR where the thickness is nonuniform in a width direction thereof.

[Rewinding Process]

Then in the pancake winding process 17 after the slitting process 16 is measured a taper amount of the pancake PC in the width direction with a measure (not shown); in a case that the magnetic tape MT is not a predetermined curvature polarity (curving direction), the wound roll is rewound on another hub (not shown), and thereby the curvature polarity is aligned (rewinding process is not shown). In this connection, if when wound on the tape reel 4, it is acceptable that the magnetic tape MT is one-sided in a width direction of the reel 4 (see fourth and fifth embodiments described later), it is not necessary to daringly rewind the tape MT on another hub.

As shown by a virtual line in the front view of the bulk roll BR of FIG. 1, because if wound on a winding face of the winding core CR, the magnetic tape whole cloth W is corrugated due to a coated magnetic paint, there also exists a variation in the curvature polarity of the magnetic tape MT slit by the slitter 2. Therefore, in the magnetic tape whole cloth W wound into an opposite side of a desired curvature polarity is rewound the pancake PC after the slitting process 16, and the curvature polarity thereof is aligned.

<Curvature Amount of Pancake and Magnetic Tape>

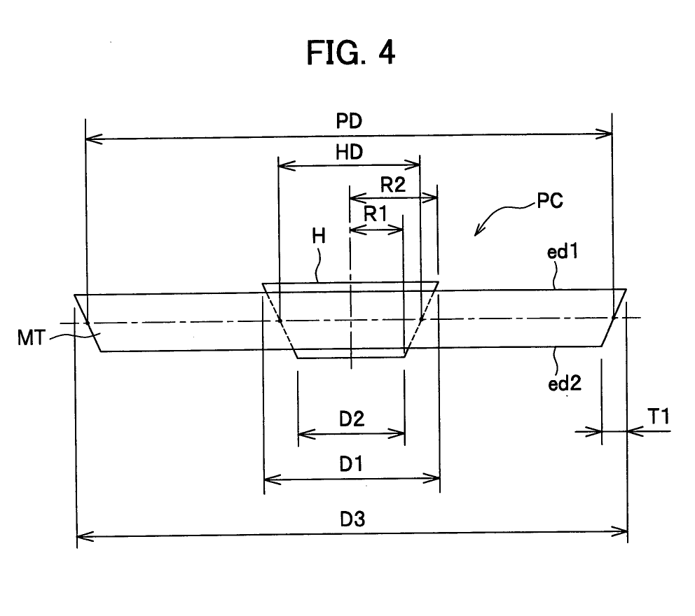

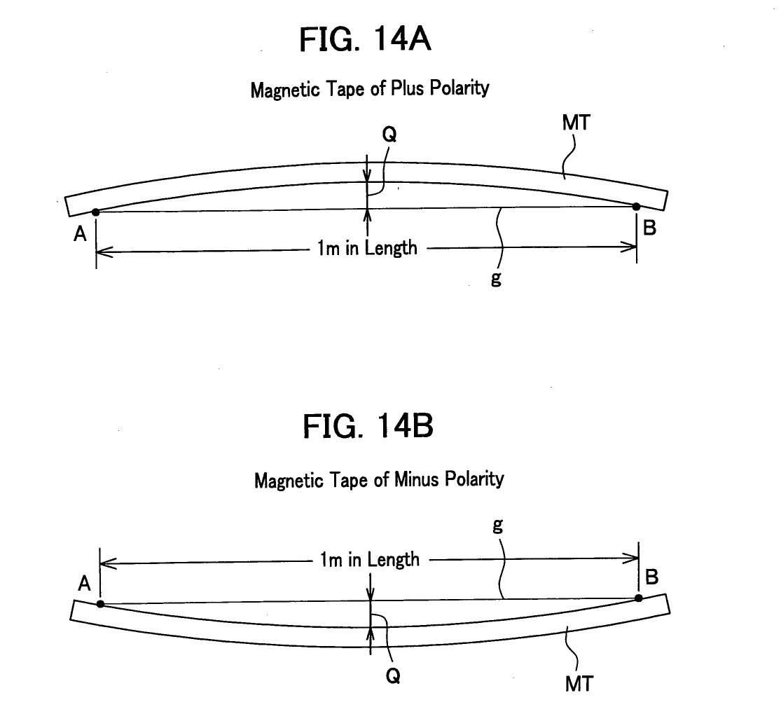

Here will be described one example of a curvature amount Q of the pancake PC and the magnetic tape MT, referring to FIGS. 4, 14A, and 14B.

Table 1 is a table showing the amount Q of the magnetic tape MT and a ratio RR (ratio of radii of both edges ed1 and ed2 in the width direction of the magnetic tape MT) of both edge radii of the magnetic tape MT (pancake PC).

A diameter HD of the hub H of the pancake PC is assumed, for example, to be not less than 115 mm, and is 0.3 to 0.99 (preferably 0.5 to 0.99) fold for a diameter PD of the pancake PC obtained. Meanwhile, in the hub H of a width of 18 mm it is assumed that the ratio (ratio of a larger radius R2 to a smaller radius R1 of the hub H: R2/R1) of both edge radii is matched with the ratio RR shown in Table 1 for the curvature amount Q given to the magnetic tape MT. In a case of changing a width of the hub H, it is assumed that R2/R1 is changed according to this as needed. Meanwhile, the curvature amount Q is a maximum distance from a standard line g connecting two arbitrary points A and B of a unit length of 1 m in a longitudinal direction to a shorter edge of the magnetic tape MT (see FIGS. 14A and 14B).

TABLE 1

| | Curvature Amount Q (mm/m) | | | | |
|---|---|---|---|---|---|
| | 05 | 1.0 | 2.0 | 4.0 | 8.0 |
| Ratio RR of Both | 1.00007 | 1.00010 | 1.00030 | 1.00060 | 1.00120 |
| Edge Radii | | | | | |

As shown in table 1, when the curvature amount Q is 0.5 mm/m, the ratio RR of both edge radii of the pancake PC is 1.00007; when the curvature amount Q is 1.0 mm/m, the ratio RR of both edge radii of the pancake PC is 1.00010; when the curvature amount Q is 2.0 mm/m, the ratio RR of both edge radii of the pancake PC is 1.00030; when the curvature amount Q is 4.0 mm/m, the ratio RR of both edge radii of the pancake PC is 1.00060; and when the curvature amount Q is 8.0 mm/m, the ratio RR of both edge radii of the pancake PC is 1.00120.

For example, the taper amount of the hub H of a thickness of 18 mm may be made 18 μm in a diameter of 250 mm according to Table 1 (RR=1.00007).

[Heat Treatment Process]

Next, for example, for a predetermined time in a constant temperature bath (not shown) is put the pancake PC consisting of the magnetic tape MT where a curvature is given in a bulk roll winding process, and a curvature form (winding tendency for ensuring a good wound form) of a desired curvature amount Q is given to the pancake PC in a heat treatment process (not shown).

Meanwhile, a heat treatment condition in the heat treatment process is preferably:
t=k×10¹⁰×T⁻⁵ (1)
where a heat treatment temperature is T (degree Celsius), a heat-treatment time is t (hr), and k is constant.

In a case of PET k≧1 is preferable. A range of the heat treatment temperature T is a temperature just under a glass transition of a base film, for example, in cases of PET and PEN the temperature is 40 to 69 degrees Celsius, preferably 55 to 65 degrees Celsius, and the heat treatment time t is 3 to 72 hours.

Meanwhile, although as an apparatus for performing the heat treatment process is used, for example, a constant temperature bath (not shown), it is not specifically limited if the magnetic tape MT can be heat-treated for a definite time at a predetermined environment temperature. In addition, because the heat treatment temperature T and the heat treatment time t differs in a material of the base film of the magnetic tape MT, they may be appropriately set, matching the material.

[Servo Signal Write Process]

Next, in a servo signal write process 20, as shown in FIG. 1, by a servo writer 8 is written a servo signal in the magnetic tape MT where a desired curvature winding tendency is given.

[Tape Reel Winding Process]

Then the magnetic tape MT is wound on the tape reel 4 by a predetermined amount and is cut by a dedicated magnetic tape winding apparatus 3 called a tape winder.

Thus the magnetic tape MT is manufactured and wound on the tape reel 4.

### First Embodiment

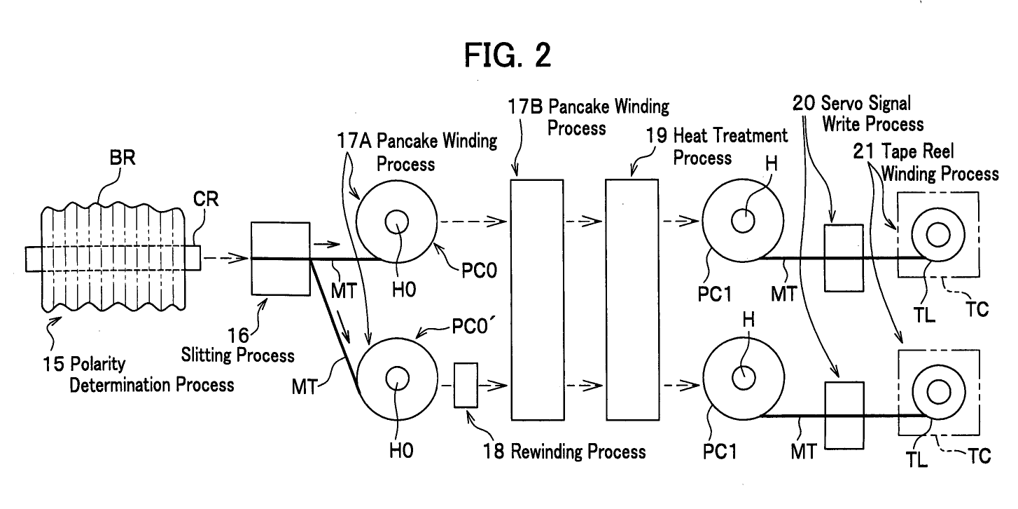

Next will be in detail described a first embodiment of a magnetic tape manufacturing method related to the present invention, referring to drawings as needed. The magnetic tape manufacturing method related to the embodiment is a method for manufacturing a magnetic tape curved in a width direction. FIG. 2 is a process chart exemplifying a series of flow until the magnetic tape is wound on a tape reel.

The magnetic tape MT related to the embodiment is manufactured from the bulk roll BR made as described before via a polarity determination process 15 and the slitting process 16. Then to the magnetic tape MT is given a form curved in a width direction via pancake winding processes 17A and 17B, a rewinding process 18, and a heat treatment process 19, and the tape MT is wound on a tape reel TL via the servo signal write process 20 and a tape reel winding process 21.

In the polarity determination process 15 is measured a form of the bulk roll BR and is determined a curvature polarity which the magnetic tape MT manufactured in the next process has in advance. The curvature polarity of the magnetic tape MT means a curvature direction in the width direction of the magnetic tape MT. For example, as shown in FIGS. 14A and 14B, it can be assumed that: a state of the magnetic tape MT curving upward in FIG. 14A is a plus direction curvature (plus polarity); a state of the magnetic tape MT curving downward in FIG. 14B is a minus direction curvature (minus polarity).

In the slitting process 16 the magnetic tape whole cloth W sent out from the bulk roll BR is slit into a predetermined width, and a plurality of magnetic tapes MT are manufactured. Each of the magnetic tapes MT manufactured in the slitting process 16 has already become a form curved in a predetermined width direction, and as described above, its curvature property is determined in advance in the polarity determination process 15. Thus it is because there exists a thickness difference in a width direction of the magnetic tape whole cloth W that the magnetic tape MT results in a curvature form from the start (in slitting).

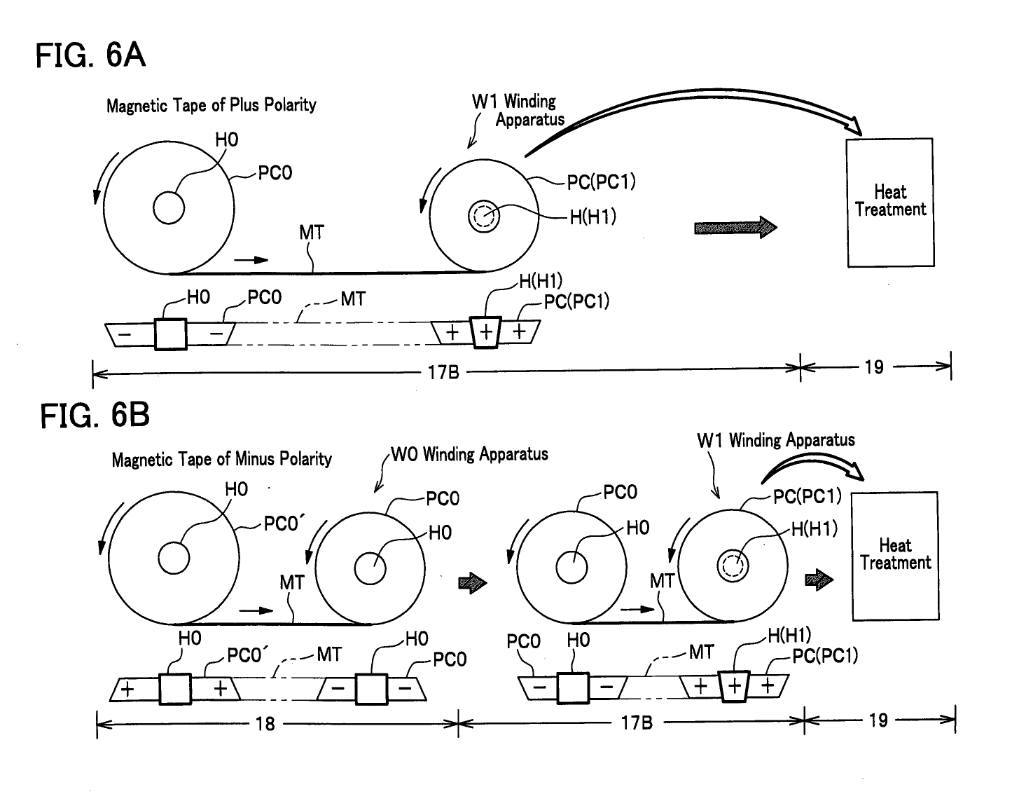

In the pancake winding process 17A the slit magnetic tape MT is wound on a hub H0 of which a winding face is flat, that is, such the hub H0 corresponding to an outer perimeter face of a column; and pancakes PC0 and PC0′ are made (see FIGS. 6A and 6B). Then, the pancake PC0 is moved to the pancake winding process 17B shown in FIG. 6A as it is. On the other hand, the pancake PC0′ is inserted in the rewinding process 18 and rewound on the hub H0 by one winding, and after then, is moved to the pancake winding process 17B. In the pancake winding process 17B the magnetic tape MT is wound on a taper hub H1 of which a winding face is a taper, and a pancake PC1 (first pancake) is made. Meanwhile, the rewinding process 18 is the process appropriately inserted between the slitting process 16 and the pancake winding process 17. These polarity determination process 15, pancake winding process 17B, and rewinding process 18 will be described later.

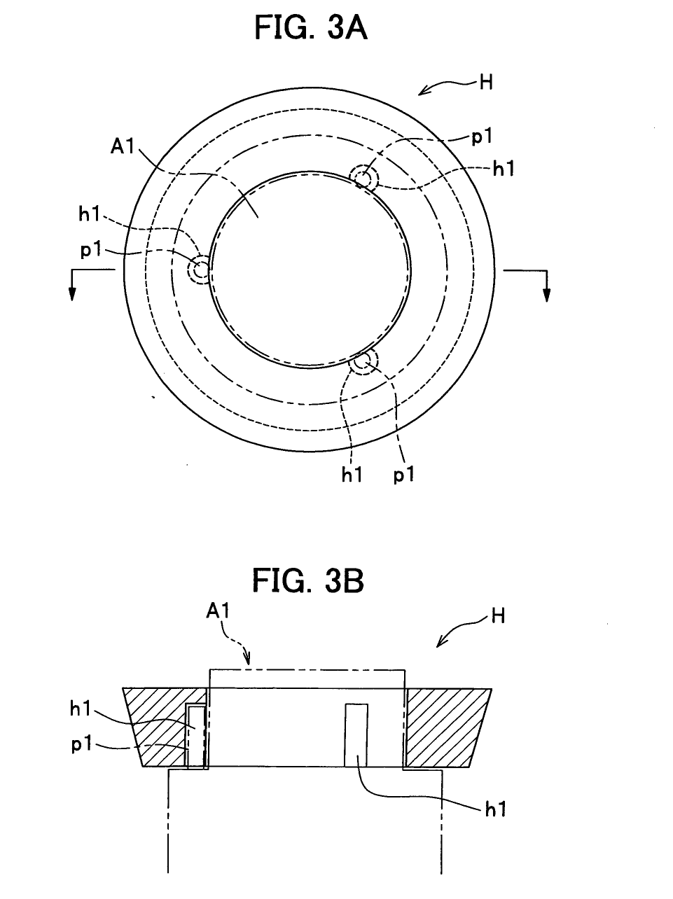

Here will be described a taper hub H, referring to FIGS. 3A, 3B, and 4. FIG. 3A is a front view of a taper hub; FIG. 3B is a section view in an arrow direction of FIG. 3A. In addition, FIG. 4 is a plan view of a pancake.

The taper hub H is composed of a material such as an epoxy resin, a phenol resin, and an AS (Acryl Styrene) resin. Furthermore, if adding a glass fiber of 10 to 40% to this material and reinforcing it, it is preferable because a deformation of the hub H is less and a desired taper amount is obtained. In addition, the taper hub H may also be molded by a die cast method, and be composed of an aluminum alloy given by alumite plating, electroless nickel plating, or Kanigen (C(K)atalytic Nickel Generation) plating after a grinding work.

As shown in FIG. 3A, the taper hub H is formed toric so as to freely fit in a winding shaft A1 shown in a chain double-dashed line, and a winding face thereof is formed like a taper. The taper hub H has three fit-in holes h1 formed at a side of an inner perimeter face along a circumferential direction at an equal pitch. The fit-in holes h1 fit in respective rotation engagement stopper pins P1 provided at the winding shaft A1, and prevent a relative rotation of the taper hub H and the winding shaft A1. Each fit-in hole h1 opens to one side face (lower face), and even if trying to fit the taper hub H in the winding shaft A1 from the other side face (upper face) where the fit-in hole h1 is not formed, a corresponding rotation engagement stopper pin P1 interferes with the hub H, and thus it is not enabled to fit the hub H in the shaft A1. Meanwhile, with respect to another taper hub H having an opposite polarity to the taper hub H shown in FIG. 3B, the fit-in holes h1 are formed on an opposite face (upper face in FIG. 3B).

In addition, as shown in FIG. 4, the taper hub H is designed so that its winding face is like a taper, in other words, a form of diameters D1 and D2 being reduced in diameter from one end to the other end, and to give a curvature form to the magnetic tape MT wound. Depending on a taper direction of the taper hub H placed, a curvature polarity given to the magnetic tape MT changes. Consequently, in the pancake winding process 17B on the taper hub H is wound the magnetic tape MT by a winding apparatus W1 where the hub H is placed in a direction corresponding to the curvature polarity of the tape MT. Meanwhile, “(the hub H is placed in) a direction corresponding to the curvature polarity of the tape MT” is such a direction that a larger diameter side (D1) matches an outside (longer edge side) of the curved magnetic tape MT.

The diameter D1 of the taper hub H is assumed to be not less than 115 mm, and is 0.3 to 0.99 (preferably 0.5 to 0.99) fold for the diameter PD of the pancake PC obtained. Meanwhile, it is assumed that a width of the hub H is set to be a desired value, based on Table 1 described before, according to the radius ratio RR of both edges of the pancake PC, that is, according to the curvature amount Q given.

In such the taper hub H a curvature polarity given to the magnetic tape MT changes, depending on an attachment direction; whereas in a hub of the NAB (National Association of Broadcasters) standard conventionally used, because any of two faces is designed to be attachable, the curvature polarity given results in an opposite due to an attachment mistake of an operator in some case. However, as described above, because the taper hub H is designed to be attachable only from one face, it is enabled to prevent an attachment mistake from occurring. Thus a manufacturing yield ratio of the magnetic tape MT is improved by preventing the attachment mistake from occurring; an operation rate is improved thanks to a workability improvement.

On the other hand, every time when the magnetic tape MT is rewound on the taper hub H, its curvature polarity is reversed. Consequently, in the embodiment, as shown in FIGS. 6A, and 6B, it is assumed in the pancake PC that: the taper hub H winding the magnetic tape MT so as to have a plus curvature is made the taper hub H1; and the taper hub H winding the magnetic tape MT so as to have a minus curvature is made a taper hub H2 (described later in another embodiment). Then it is assumed that: the pancake PC comprising the taper hub H1 is the pancake PC1 of a plus polarity; and the pancake PC comprising the taper hub H2 is a pancake PC2 of a minus polarity. In addition, it is assumed that: out of the pancakes PC0 and PC0′ comprising the taper hub H0 a pancake of which a curvature polarity is a minus polarity is PC0; and a pancake of which a curvature polarity is a plus polarity is PC0′. Meanwhile, as shown in FIG. 4, it is assumed in the pancake PC that a radius difference of the both edges ed1 and ed2 in a width direction of the magnetic tape MT is a taper amount T1.

In the heat treatment process 19 a winding tendency is given to ensure a good wound form by keeping the pancake PC for a predetermined time under a predetermined environment temperature and heat-treating the pancake PC. In this process the pancake PC is heat-treated under a condition that the equation (1) is satisfied.

Then in the servo signal write process 20 a servo signal is written in the magnetic tape MT, and after then, in the tape reel winding process 21 the tape MT is wound on the tape reel TL. Thus the magnetic tape MT wound on the tape reel TL is built in a cartridge case TC and shipped.

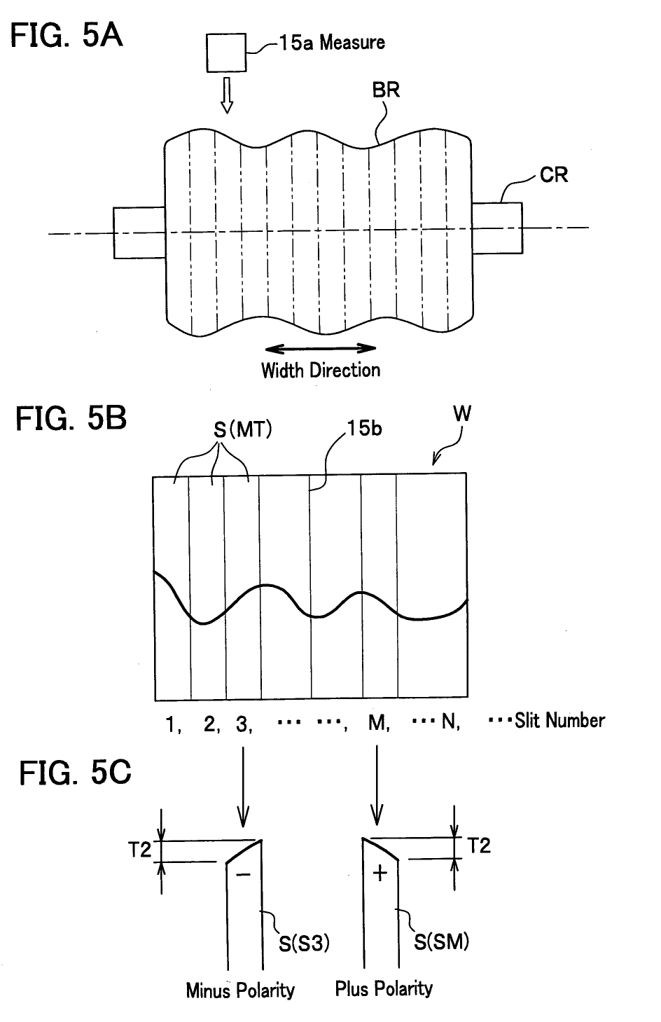

Next will be described the polarity determination process 15 in detail, referring to FIGS. 5A, 5B, and 5C. FIGS. 5A to 5C are drawings illustrating a method for determining a curvature polarity of the magnetic tape MT; FIG. 5A is a front view of the bulk roll BR; FIG. 5B is a form measurement result of the bulk roll BR; and FIG. 5C is an illustration drawing of a polarity determination according to the measurement result of FIG. 5B.

Firstly, a curvature polarity possessed in advance by the magnetic tape MT is caused by thickness of the magnetic tape whole cloth W (see FIG. 2), and is correlated with a profile form of the bulk roll BR influenced by the thickness. Consequently, in the polarity determination process 15 the profile form of the bulk roll BR is measured by a measure 15a such as a laser displacement meter or a probe profilometer, and from this result, the curvature polarity of the magnetic tape MT manufactured in the next process is determined in advance. Meanwhile, chain double-dashed lines on a surface of the bulk roll BR in FIG. 5A shows slit lines in the next process (that is, boundary 15b of each magnetic tape MT).

In the measure 15a shown in FIG. 5A the surface of the bulk roll BR is traced, for example, by a laser displacement meter, its profile form is measured (upper half profile in the embodiment), and data taken is processed, and such a coordinate calculation is analyzed. A measurement result of the measure 15a is shown in FIG. 5B. In the measurement result the measure 15a determines each positional coordinate (slit number: 1, 2, 3, . . . , M, . . . , N) in a width direction of each magnetic tape MT (hereinafter referred to as “slit S” in the process) slit in the next process in a state of the bulk roll BR, and as shown in FIG. 5C, calculates a taper amount T2 (taper amount of the outer perimeter of the bulk roll BR) of each slit S. Here, the taper amount T2 means a radius difference at both edges of each slit S in the width direction.

In the measure 15a, for example, in a case that the taper amount T2 of the slit S3 of the slit number 3 becomes minus, it is determined that the magnetic tape MT manufactured from this position becomes the plus polarity in the state of the bulk roll BR; and in a case that the taper amount T2 of the slit SM of the slit number M becomes plus, the magnetic tape MT manufactured from this position becomes the minus polarity in the state of the bulk roll BR. Thus the curvature polarity (polarity in the first winding) is determined that the magnetic tape MT manufactured from the bulk roll BR has in advance.

Meanwhile, because if the direction of the taper hub H is mistaken, a yield ratio of the magnetic tape MT is lowered, it is preferable to administer the polarity of a wound roll (bulk roll BR, pancake PC) and the direction of the taper hub H, relating them according to the slit number by a trace system through a hand written slip or a data base.

Next will be described the pancake winding process 17B and the rewinding process 18, referring to FIGS. 6A and 6B. FIGS. 6A and 6B are illustration drawings of the pancake winding process 17B, the rewinding process 18, and the heat treatment process 19 related to the first embodiment; FIG. 6A is the winding process of the magnetic tape MT having a plus polarity; and FIG. 6B is the winding process of the magnetic tape having a minus polarity. Meanwhile, in FIGS. 6A and 6B upper and lower drawings show side views and plan views, respectively.

Firstly, it becomes a precondition that: the pancake winding process 17B is after the pancake winding process 17A; and the magnetic tape MT obtained from the bulk roll BR via the slitting process 16 is wound on the hub H0 of which a winding face is flat, and has become the pancakes PC0 and PC0′. At this time, as shown in FIG. 6A, the magnetic tape MT determined as the plus polarity in a state of the bulk roll BR changes in its polarity by being wound on the hub H0, and thereby the pancake PC0 is made. In addition, as shown in FIG. 6B, the magnetic tape MT determined as the minus polarity in a state of the bulk roll BR changes in its polarity by being wound on the hub H0, and thereby the pancake PC0′ is made. In the pancake winding process 17B of the embodiment, in order to obtain the pancake PC1 having a desired polarity (plus polarity), if a preconditioned pancake is the pancake PC0, it is wound as it is; if the preconditioned pancake is the pancake PC0′, the rewinding process 18 is inserted before the pancake winding process 17B.

Firstly will be described a case that the pancake PC0 is obtained. As shown in FIG. 6A, in the pancake winding process 17B at the winding apparatus W1 is placed the taper hub H1 corresponding to the curvature polarity of the magnetic tape MT.

As shown in FIG. 6A, the magnetic tape MT sent out from the pancake PC0 is wound on the taper hub H1 placed at the winding apparatus W1, the curvature polarity of the tape MT changes to the plus, and the pancake PC1 is made. In other words, the pancake PC1 is made by the taper hub H1 of which the direction of the taper matches the plus polarity of the magnetic tape MT. Then the pancake PC1 made is moved to the heat treatment process 19 as it is, and a good curvature form (the form in a state of the curvature polarity of the magnetic tape MT and the direction of the taper of the taper hub H1 being matched) is given.

Next will be described a case that the pancake PC0′ is obtained. In this case, the pancake PC0′ is rewound in the rewinding process 18 inserted before the pancake winding process 17B and is made the pancake PC0, and then the pancake PC0 is moved to the process 17B.

As shown in FIG. 6B, the magnetic tape MT sent out from the pancake PC0′ is firstly wound on the hub H0 placed at a winding apparatus W0, the curvature polarity of the tape MT changes to the minus, and the pancake PC0 is made. In other words, rewinding the magnetic tape MT, the polarity changes and the pancake PC0 same as in FIG. 6A is obtained. Then the pancake PC0 is wound in the next pancake winding process 17B.

As shown in FIG. 6B, in the pancake winding process 17B at the winding apparatus W1 is placed the taper hub H1. The pancake PC0 made in the rewinding process 18 is made upside down and placed at a supply reel side of the winding apparatus W1, and is rewound on the taper hub H1. Thus the pancake PC1 is made from the pancake PC0. Then same as described above, after the pancake winding process 17B the pancake PC1 made is moved to the heat treatment process 19, and a good curvature form is given thereto.

Thus the following effect can be obtained in the embodiment.

In the polarity determination process 15 is the curvature polarity possessed in advance by the magnetic tape MT; the tape MT is once wound on the taper hub H0 of which the winding face is flat; and after then, in the pancake winding process 17B, is wound on the taper hub H1 corresponding to the curvature polarity of the tape MT. If the curvature polarity possessed in advance by the magnetic tape MT does not match the direction of the taper hub H, a curvature form at an outer perimeter side of the pancake PC1 becomes unstable; however, in the embodiment, because the direction of the taper hub H is made to correspond to the curvature polarity of the magnetic tape MT, the curvature polarity of the plus polarity same as at an inner perimeter side can stably be given to the outer perimeter side of the pancake PC. In addition, by inserting the rewinding process 18, all pancakes PC made can be obtained as the pancakes PC1 where the polarity of the magnetic tape MT is unified in the plus direction. In this connection, the curvature amount Q of the magnetic tape MT thus manufactured is about 0.5 to 4.0 mm/m (preferably 0.5 to 2.0 mm/m).

Thus, aligning the curvature polarity given and reducing a variation thereof, it is enabled to ensure the wound form of the magnetic tape MT, obtain a stability in carrying the tape MT, and reduce cost thanks to the improvement of the yield ratio.

In addition, because the pancakes PC0, PC0′, PC1, and PC2 are only placed on the winding apparatus W1 and a winding apparatus W2 where the taper hubs H 1 and H2 corresponding to the curvature polarities possessed in advance by the pancakes (magnetic tape MT), such an attachment of the taper hub H1 and H2 does not become burdensome, and it is simple in the processes.

Thus, although the first embodiment of the present invention is described, the invention is not limited thereto. In the embodiment, with respect to the pancake PC0′, although the rewinding process 18 is inserted and all pancakes PC1 of the plus polarity are made, the present invention is not limited thereto; for example, with respect to the pancake PC0 the rewinding process 18 is inserted, and all pancakes PC2 of the minus polarity can be obtained. Thus it is enabled to obtain the pancake PC2 where the polarity of the magnetic tape MT is unified in the minus direction.

In addition, although in the embodiment each process is formally described, in a practical process are matched the selection of the pancake PC and the direction of the taper hub H, depending on rewinding times in a following process and a needed curvature polarity.

In the embodiment, although in the polarity determination process 15 is measured the form of the bulk roll BR and is determined the curvature polarity possessed in advance by the magnetic tape MT, the present invention is not limited thereto; for example, measuring the curvature amount Q (see FIGS. 14A and 14B) of the tape MT while from the slitting process 16 to the pancake winding process 17A, and based on the measurement result, it is also enabled to determine the curvature polarity of the tape MT. For example, it is assumed that: if the curvature amount Q is the plus, it is the plus curvature; and if the curvature amount Q is the minus, it is the minus curvature.

### Second Embodiment

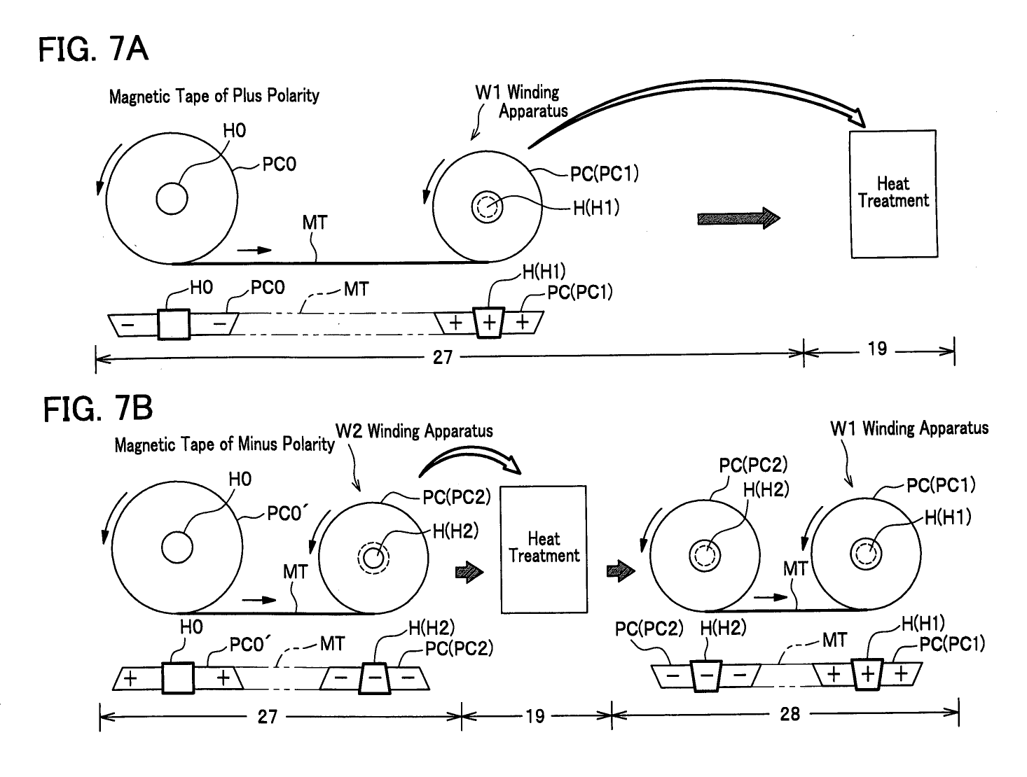

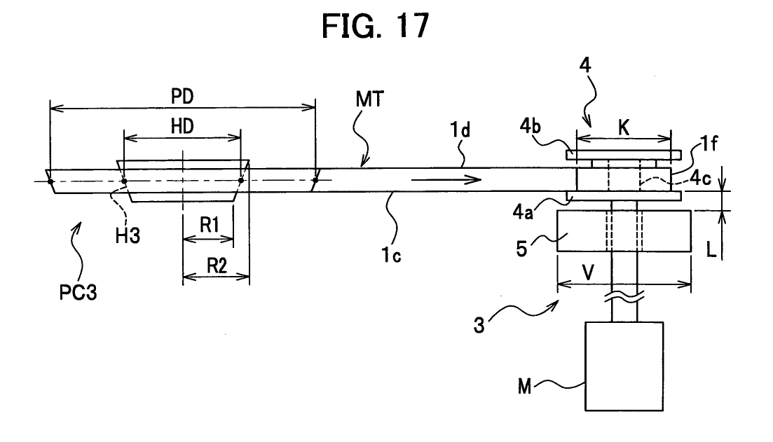

Next will be in detail described a second embodiment of a magnetic tape manufacturing method related to the present invention, referring to drawings as needed. FIGS. 7A and 7B are illustration drawings of a pancake winding process, a rewinding process, and a heat treatment process related to the second embodiment; FIG. 7A is a winding process of the magnetic tape MT having a plus polarity; and FIG. 7B is a winding process of the magnetic tape MT having a minus polarity. Meanwhile, in FIGS. 17A and 17B upper and lower drawings shows side views and plan views, respectively.

The magnetic tape manufacturing method related to the second embodiment is the manufacturing method in that of the first embodiment where a configuration of the pancake winding process 17B, the rewinding process 18, and the heat treatment process 19 (see FIG. 2) after the polarity determination process 15 and the slitting process 16 is changed; Here will be described a pancake winding process 27, the heat treatment process 19, and a rewinding process 28 related to the embodiment.

Firstly, as a precondition the curvature polarity of the magnetic tape MT wound on the bulk roll BR is determined in the polarity determination process 15 shown in FIG. 2. Then in the pancake winding process 17A the magnetic tape MT slit is wound on the hub H0 of which a winding face is flat, the pancakes PC0 and PC0′ are made, and in the pancake winding process 27 the magnetic tape MT of the pancakes PC0 and PC0′ are wound on the taper hub H (H1, H2) of which a winding face is a taper, and thus the pancake PC (PC1, PC2) is made.

In the pancake winding process 27 is made the pancake PC1 from the pancake PC0 as shown in FIG. 7A by being wound with the winding apparatus W1 where the taper hub H1 for giving the plus polarity is placed. Then moving the pancake PC1 to the heat treatment process 19 as it is, a good curvature form is given.

On the other hand, as shown in FIG. 7B, the pancake PC2 is made from the pancake PC0′ as shown in FIG. 7B by being wound with the winding apparatus W2 where the taper hub H2 for giving the minus polarity is placed. The pancake PC2 has the minus polarity. Then moving the pancake PC2 to the heat treatment process 19 as it is, a good curvature form is given.

Furthermore, the pancake PC2 after the heat treatment process 19 is made upside down in the rewinding process 28 and rewound by the winding apparatus W1 where the taper hub H1 for giving the plus curvature polarity is placed. Thus the pancake PC1 of the plus polarity can be made.

Thus the following effect can be obtained in the embodiment.

The curvature polarity possessed in advance by the magnetic tape MT is determined, and in the pancake winding process 27, if the tape MT is the plus polarity, it is wound on the taper hub H1 for giving the plus polarity; if the tape MT is the minus polarity, it is wound on the taper hub H2 for giving the minus polarity. If the curvature polarity possessed in advance by the magnetic tape MT does not match the direction of the taper hub H, a curvature form at an outer perimeter side of each of the pancakes PC1 and PC2 becomes unstable; however, in the embodiment, because the pancakes PC1 and PC2 are wound on the respective taper hubs H1 and H2 matching the curvature polarity of the magnetic tapes MT, a curvature form of the plus polarity same as at an inner perimeter side can be stably given to the outer perimeter side of each pancake PC1.

Thus, aligning the curvature polarity given and reducing a variation thereof, it is enabled to ensure the wound form of the magnetic tape MT, obtain a stability in carrying the tape MT, and reduce cost thanks to the improvement of the yield ratio.

In addition, because the pancake PC2 is manufactured as the pancake PC1 having the plus polarity via the rewinding process 28 rewound on the taper hub H1 after the heat treatment process 19, also in the embodiment all pancakes PC1 can be obtained where the polarity of the magnetic tape MT is unified in the plus direction.

Although the second embodiment of the present invention is thus described, the invention is not limited thereto. In the embodiment, in order to obtain the pancake PC1 of the plus polarity, the rewinding process 28 is inserted after the heat treatment process 19, the pancake PC2 of the minus polarity is rewound, and thereby the pancake PC1 of the plus polarity is obtained; however, in a case that the pancake PC2 of the minus polarity is used as it is, the rewinding process 28 can also be omitted. Depending on a product of a magnetic tape cartridge, in some case the pancake PC2 of the minus polarity is used other than the pancake PC1 of the plus polarity, the rewinding process 28 is not always needed.

### Third Embodiment

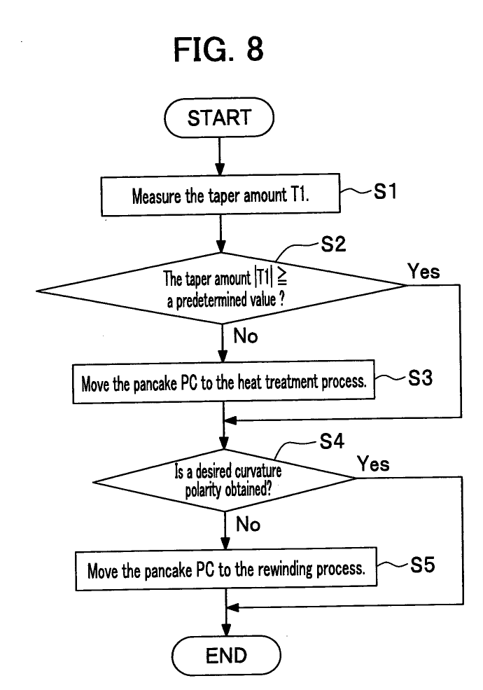

Next will be in detail described a third embodiment of a magnetic tape manufacturing method related to the present invention, referring to drawings as needed. FIG. 8 is a flowchart of a control unit related to the embodiment. Because the third embodiment is the magnetic tape manufacturing method where a determination of the control unit (not shown) is added to determine whether or not each process is omitted in the magnetic tape manufacturing method related to the second embodiment, it will be described, referring to FIGS. 7A and 7B as needed. Meanwhile, with respect to a same configuration as in the second embodiment, a same symbol is appended and a description thereof is omitted.

The magnetic tape manufacturing method related to the embodiment comprises in the heat treatment process 19 shown in FIGS. 7A and 7B a process of determining whether or not the control unit not shown omits the heat treatment process 19 and the rewinding process 28 after the pancake winding process 27.

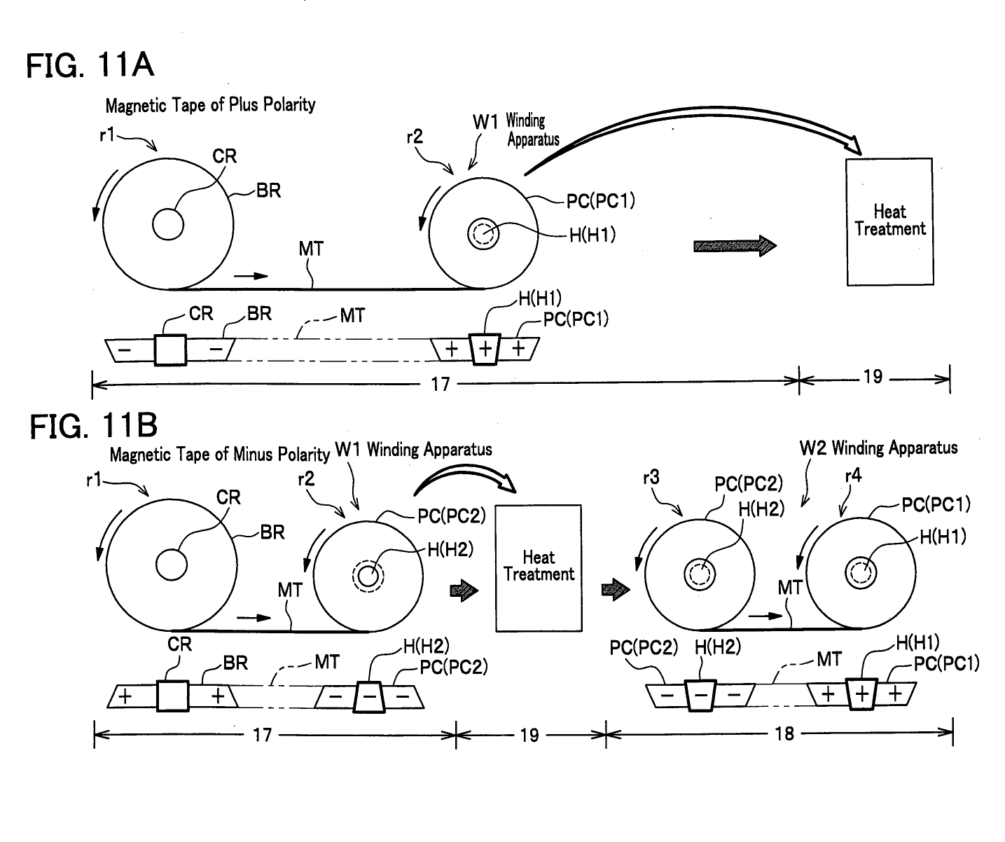

As shown in FIG. 8, the control unit not shown measures (step S1) the taper amount T1 (see FIG. 4) of the pancake PC (PC1, PC2) after the pancake winding process 27 shown in FIGS. 7A and 7B. The taper amount T1 is correlated with the curvature amount Q (see FIGS. 11A and 11B) of the magnetic tape MT of the pancake PC (PC1, PC2).

Then the control unit determines whether or not an absolute value of the taper amount T1 is not less than a predetermined value (step S2). If the absolute value of the taper amount T1 is not less than the predetermined value (Yes in the step S2), the magnetic tape MT of the pancake PC measured is moved to a step S4 not via the heat treatment process 19 (see FIG. 7A), assuming that the tape MT has obtained a desired curvature amount Q. On the other hand, if the absolute value of the taper amount T1 is no more than the predetermined value (No in the step S2), the magnetic tape MT is moved to a step S3, assuming that the tape MT has not obtained the desired curvature amount Q, and the pancake PC is treated at the heat treatment process 19 (see FIG. 7B). By treating the pancake PC in the heat treatment process 19, the magnetic tape MT is stress-relieved, copying each taper hub H and a desired curvature form is given.

Next, the control unit determines whether or not the pancake PC obtained is a desired curvature polarity (the step S4). If the pancake PC is the desired curvature polarity (for example, plus polarity) (Yes in the step S4), the processing ends as it is and the pancake PC is moved to the next process (servo signal write process 20 shown in FIG. 2 and the like). On the other hand, if the pancake PC is not the desired curvature polarity (for example, plus polarity) (No in the step S4), as shown in FIG. 7B, the pancake PC is moved to the rewinding process 28 (step S5). For example, rewinding the pancake PC2, the pancake PC1 having the desired curvature polarity is obtained. After then the processing ends.

Thus the following effect can be obtained in the embodiment.

In accordance with the embodiment it is enabled to obtain the pancake PC of the desired curvature form and the curvature polarity and to efficiently omit each process. Therefore, it is enabled to achieve a cost reduction and a manpower alleviation thanks to a manpower reduction.

Thus although the third embodiment of the present invention is described, the invention is not limited thereto. In the embodiment, although the rewinding process 28 (steps S4 and S5) is inserted after the heat treatment process 19 (steps S2 and S3), the present invention is not limited thereto; for example, the heat treatment process 19 (steps S2 and S3) may also be inserted after the rewinding process 28 (steps S4 and S5). Also according to this, the same effect can be obtained. In addition, if not focusing on the curvature polarity, the steps S4 and S5 can also be omitted.

In the embodiment, although it is determined whether or not a heat treatment is treated, based on the taper amount T1 of the pancake PC, it may also determined whether or not the heat treatment is treated, based on an outer perimeter taper amount of the form of the bulk roll BR. In addition, in the embodiment, although the rewinding process 28 is inserted after the pancake winding process 27, it may also be determined to rewind the pancake PC before the process 27.

<Variation Example of Taper Hub.

Next will be described a taper hub H′ of a variation of the taper hub H.

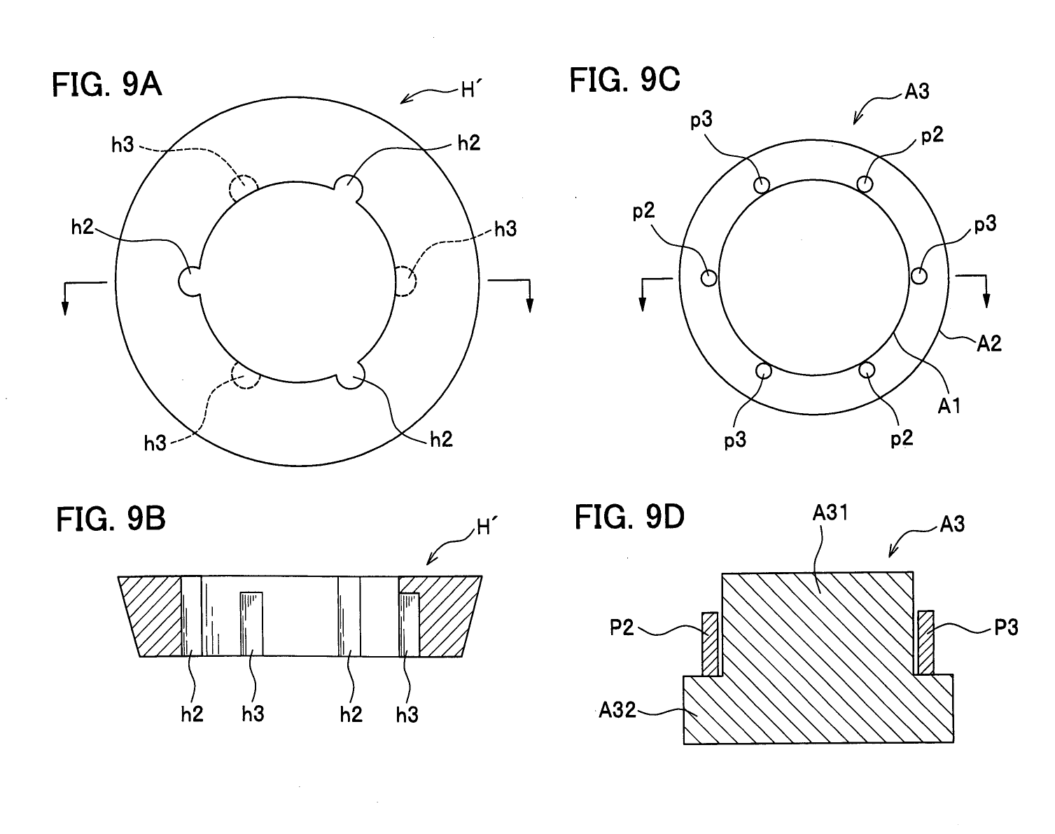

FIG. 9A is a front view of a taper hub H′; FIG. 9B is a section view in an arrow direction of FIG. 9A; FIG. 9C is a front view of a winding shaft A3; and FIG. 9D is a section view in an arrow direction of FIG. 9C.

As shown in FIGS. 9A and 9B, the taper hub H′ is formed toric (see FIG. 9A) so as to freely fit in the winding shaft A3 shown in FIGS. 9C and 9D, and has three fit-in holes h2 formed at an inner perimeter side along a circumferential direction at an equal pitch; and three fit-in holes h3 formed at positions where phases of the holes h3 and h2 are displaced, respectively (see FIG. 9A). The fit-in holes h2 respectively fit in fit-in pins p2 provided at the winding shaft A3 described later, and are a fit-in hole for a hub of the NAB standard. In addition, the fit-in holes h3 are respectively fit in fit-in pins p3 provided at the winding shaft A3 described later, and as shown in FIG. 9B, are formed, opening to only one side face.

As shown in FIG. 9D, the winding shaft A3 fitted in by the taper hub H′ is formed like a column with a step consisting of a smaller diameter portion A31 and a larger diameter portion A32, and comprising three fit-in pins p2 protruding from the portion A32 in an axial direction and three fit-in pins p3 protruding likewise. The fit-in pins p2 is a fit-in pin for a hub of the NAB standard. In addition, the fit-in pins p3 is a pin for preventing an attachment mistake of the taper hub H′. In other words, even if trying to fit the taper hub H′ in the winding shaft A3 from a side where the fit-in pins p3 are not formed, it is designed that: the fit-in pins p3 interfere with the taper hub H′; the hub H′ cannot fit in the winding shaft A3; and thus it is enabled to prevent the attachment mistake of the taper hub H′.

In accordance with such the taper hub H′ and the winding shaft A3, the attachment mistake of the taper hub H′ is prevented from occurring, thereby a manufacturing yield ratio is improved, and an operation rate is improved thanks to an improvement of the workability.

Meanwhile, although in the embodiment each number of the fit-in pins p2, p3 and the fit-in holes h2, h3 is assumed three, the present invention is not limited thereto; it is appropriately changeable to one or more than one.

### Fourth Embodiment

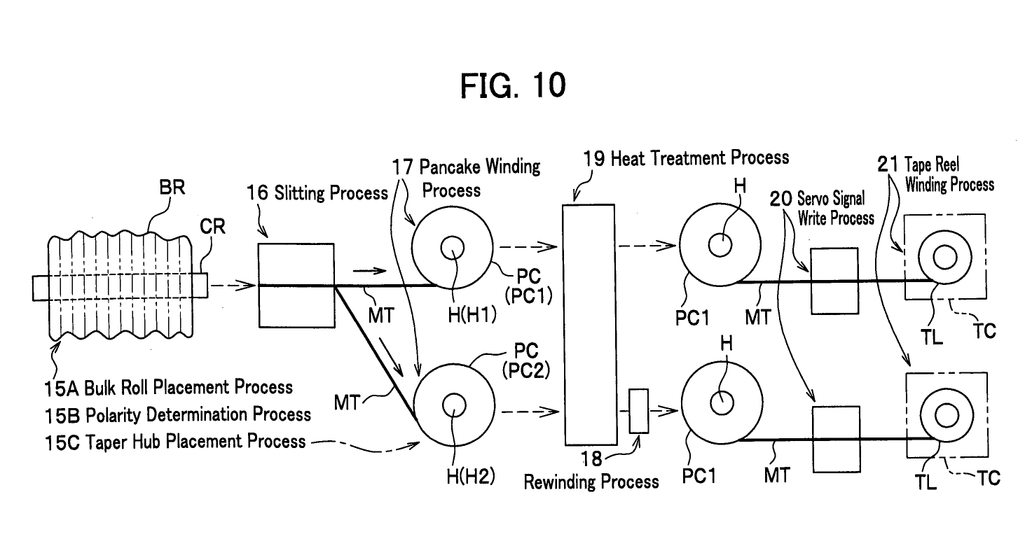

Next will be in detail described a fourth embodiment of a magnetic tape manufacturing method related to the present invention, referring to drawings as needed. The magnetic tape manufacturing method related to the embodiment is a method for winding a magnetic tape on a taper hub having a taper winding face. FIG. 10 is a process chart exemplifying a series of flow until the magnetic tape MT is wound on the tape reel TL.

The magnetic tape MT related to the embodiment is manufactured from the bulk roll BR made as described before, via a bulk roll placement process 15A, a polarity determination process 15B, a taper hub placement process 15C, and the slitting process 16. Then, to the magnetic tape MT is given a form curved in a width direction via the pancake winding process 17, the heat treatment process 19, and the rewinding process 18; and the tape MT is wound on the tape reel TL via the servo signal write process 20 and the tape reel winding process 21.

In the bulk roll placement process 15A the bulk roll BR is placed at a supply reel r1 side of the winding apparatus W1 shown in FIGS. 11A and 11B.

In the polarity determination process 15B is measured a form of the bulk roll BR placed and is determined a curvature polarity possessed in advance by the magnetic tape MT manufactured in the next process. The curvature polarity of the magnetic tape MT means a curvature direction in the width direction of the magnetic tape MT. For example, as shown in FIGS. 14A and 14B, it can be assumed that: a state of the magnetic tape MT curving upward as in FIG. 14A is a plus direction curvature (plus polarity); and a state of the magnetic tape MT curving downward as in FIG. 14B is made a minus direction curvature (minus polarity). Meanwhile, because the polarity determination process 15B is same as the polarity determination process 15 in the first embodiment described in detail, referring to FIGS. 5A, 5B, and 5C, a duplicated description thereof is omitted.

In the taper hub placement process 15C (see FIG. 10) the taper hub H is placed at a take-up reel r2 side of the winding apparatus W1 shown in FIGS. 11A and 11B in a direction corresponding to the curvature polarity of the magnetic tape MT. Thus the winding apparatus W1 where the taper hub H is placed, matching the curvature polarity of the magnetic tape MT, has the following advantages, compared to a winding apparatus where a taper hub is placed in advance. In other words, because a winding apparatus where a taper hub is placed in advance matches a curvature polarity of a magnetic tape with the taper hub of the winding apparatus, in a case of the curvature polarity of the tape not matching that of the hub, it is necessary to once rewind the tape to change the polarity and then to place the tape on the winding apparatus. In this case such problems are considered: an introduction of new equipment for rewinding; an equipment investment such as a construction of a trace information system of the magnetic tape rewound and the hub polarity, and an increase of labor cost accompanied therewith; an increase of the process; an increase of an intermediate inventory accompanied with the increase of the process; and an increase of the administration cost of the intermediate inventory. On the contrary, in the winding apparatus W1 of the embodiment such the problems are eliminated. Meanwhile, although the taper hub placement process 15C is a process entered before the pancake winding process 17 (see FIG. 10), it is the process relating to the winding apparatus W1 (see FIGS. 11A and 11B) of the pancake winding process 17; and so in FIG. 10 is shown a chain line arrow mark leading to the process 17. Meanwhile, “(the taper hub H is placed) in a direction corresponding to the curvature polarity of the magnetic tape MT” is such a direction that a larger diameter side of the taper hub H matches an outside (longer edge side) of the magnetic tape MT curved.

In the slitting process 16 the magnetic tape whole cloth W sent out from the bulk roll BR is slit into a predetermined width and several magnetic tapes MT. Each of the magnetic tapes MT manufactured in the slitting process 16 already becomes a form curved in a predetermined width direction in slitting, and as described before, its curvature polarity is determined in advance in the polarity determination process 15B. It is because there exists a thickness difference in a width direction in the magnetic tape whole cloth W that the magnetic tape MT is a curved form from the start (in slitting).

In the pancake winding process 17 the magnetic tape MT slit is wound on the taper hub H (H1, H2), and the pancake PC (PC1, PC2) is made. Here will be described the pancake PC and the taper hub H, referring to FIG. 4. It is preferable in the taper hub H to use a reinforced substance, for example, by adding a glass fiber by 10 to 40% to a material such as a metal like aluminum, an epoxy resin, a phenol resin, or an AS resin.

As shown in FIG. 4, the taper hub H is a taper in its winding face, that is, a form reduced from the diameter D1 to the diameter D2 across one end to the other end, and gives a curvature form to the magnetic tape MT wound. Depending on a taper direction at the time when the taper hub H is placed, a curvature polarity given to the magnetic tape MT changes. Consequently, in the pancake winding process 17, placing the taper hub H in a direction corresponding to the curvature polarity of the magnetic tape MT, the magnetic tape MT is wound on the taper hub H. Meanwhile, “placing the taper hub H in a direction corresponding to the curvature polarity of the magnetic tape MT” means such a direction that: an outside edge (longer side edge) of the magnetic tape MT matches the larger diameter (D1) side of the taper hub H; and the inside edge (shorter side edge) of the magnetic tape MT matches the smaller diameter (D2) side of the taper hub H.

The diameter D1 of the taper hub H is assumed to be not less than 115 mm, and is 0.3 to 0.99 (preferably 0.5 to 0.99) fold for the diameter D3 of the pancake PC obtained. Meanwhile, the width of the taper hub H is assumed to be set to a desired value according to the radius ratio RR of both edges, that is, the curvature amount Q given, based on Table 1 described before.

In addition, every time when the magnetic tape MT is rewound on the taper hub H, its curvature polarity is reversed. Consequently, in the embodiment, as shown in FIGS. 11A and 11B, it is assumed in the pancake PC that: the taper hub H for winding the magnetic tape MT so as to have the plus polarity is the taper hub H1, and the taper hub H for winding the magnetic tape MT so as to have the minus polarity is the taper hub H2; then the pancake PC comprising the taper hub H1 is the pancake PC1 of the plus polarity, and the pancake PC comprising the taper hub H2 is the pancake PC2 of the minus polarity. Meanwhile, as shown in FIG. 4, it is assumed in the pancake PC that the radius difference of the both edges ed1 and ed2 in the width direction of the magnetic tape MT is the taper amount T1.

Returning to FIG. 10, a description will be continued. The rewinding process 18 is a process of rewinding the pancake PC (PC2) made in the pancake winding process 17 on the taper hub H (H1) according to a determination result in the polarity determination process 15B. Thus the polarity of the pancake PC is changed, and the pancake PC2 becomes the pancake PC1. The rewinding process 18 is a process inserted as needed according to the determination result in the polarity determination process 15B. The pancake winding process 17 and the rewinding process 18 will be described later in detail.

In the heat treatment process 19 is given a winding tendency for ensuring a good wound form by keeping the pancake PC for a predetermined time under a predetermined environment temperature. In this process the pancake PC is heat-treated under a condition satisfying the equation (1).

Then in the servo signal write process 20 a servo signal is written in the magnetic tape MT sent out from the pancake PC, and after then, in the tape reel winding process 21 the tape MT is wound on the tape reel TL. Thus the tape MT wound on the tape reel TL is built in the cartridge case TC and shipped.

Next will be described the pancake winding process 17 and the rewinding process 18, referring to FIGS. 11A and 11B. FIGS. 11A and 11B are illustration drawings of the pancake winding process 17, the rewinding process 18, and the heat treatment process 19 related to a fourth embodiment; FIG. 11A is a winding process of the magnetic tape MT having the plus polarity; and FIG. 11B is a winding process of the magnetic tape having the minus polarity. Meanwhile, in FIGS. 11A and 11B upper and lower drawings show side views and plan views, respectively.

Firstly will be described the winding apparatus W1 used in the pancake winding process 17 and the winding apparatus W2 used in the rewinding process 18. The winding apparatus W1 comprises the supply reel r1, the take-up reel r2, and a slitter not shown. On the supply reel r1 is placed the bulk roll BR consisting of the magnetic tape whole cloth W. In addition, on the take-up reel r2 is placed the taper hub H so as to correspond to the curvature polarity of the magnetic tape MT according to the determination result in the polarity determination process 15B. Then the slitter not shown is provided between the supply reel r1 and the take-up reel r2, slits the magnetic tape whole cloth W sent out from the bulk roll BR into a predetermined width, and makes the magnetic tape MT. The slitter is one used in the slitting process 16.

In addition, the winding apparatus W2 comprises a supply reel r3 and a take-up reel r4. On the supply reel r3 is placed the pancake PC2 (described later in detail) wound on the take-up reel r2 of the winding apparatus W1. In addition, on the take-up reel r4 is placed the taper hub H having an opposite polarity to the determination result. Here will be described each process.

As shown in FIGS. 11A and 11B, in the pancake winding process 17 on the winding apparatuses W1 are placed the taper hubs H1 and H2, respectively, corresponding to the curvature polarities of respective magnetic tapes MT.

Firstly will be described the pancake winding process 17 of the magnetic tape MT determined as the plus polarity. As shown in FIG. 11A, the magnetic tape MT determined as the plus polarity in a state of the bulk roll BR and manufactured is wound on the taper hub H1 placed at the winding apparatus W1, and thus the pancake PC1 is made. In other words, the pancake PC1 is made by the taper hub H1 of which the taper direction is matched with the plus polarity possessed in advance by the magnetic tape MT. Then the pancake PC1 made is moved to the heat treatment process 19 as it is, and a good curvature form (curvature form in the state of the plus polarity of the tape MT being matched with the taper direction of the taper hub H1) is given thereto.

Next will be described the pancake winding process 17 of the magnetic tape MT determined as the minus polarity. As shown in FIG. 11B, the magnetic tape MT determined as the minus polarity in a state of the bulk roll BR and manufactured is wound on the taper hub H2 placed at the winding apparatus W1, and thus the pancake PC2 is made. In other words, the pancake PC2 is made by the taper hub H2 of which the taper direction is matched with the minus polarity possessed in advance by the magnetic tape MT. Then the pancake PC2 made is moved to the heat treatment process 19 as it is, and a good curvature form is given thereto. After then the pancake PC2 is rewound in the next rewinding process 18.

In the rewinding process 18 on the winding apparatus W2 is placed the taper hub H1 of the opposite polarity to that determined in the polarity determination process 15B. The pancake PC2 made in the pancake winding process 17 is made upside down and placed on the supply reel r3 of the winding apparatus W2, and is rewound on the taper hub H1. Thus the pancake PC1 is made from the pancake PC2.

Thus the following effect can be obtained in the embodiment.

Determining the curvature polarity possessed in advance by the magnetic tape MT in the polarity determination process 15B, each magnetic tape MT is wound on the taper hub H (H1, H2) corresponding to the curvature polarity of the tape MT. If the curvature polarity possessed in advance by the magnetic tape MT does not match the direction of the taper hub H, a curvature form at the outer perimeter side of the pancake PC (PC1, PC2) becomes unstable; however, in the embodiment, because the direction of the taper hub H is made to correspond to the curvature polarity of the magnetic tape MT and thus the heat treatment is treated, it is enabled to stably give the outer perimeter side the curvature form of the plus polarity same as the inner perimeter side. In addition, inserting the rewinding process 18, it is enabled to obtain the pancake PC to be made as the pancake PC1 where the polarity of the magnetic tape MT is unified in the plus direction.

Thus, aligning the curvature polarity given and reducing a variation thereof, it is enabled to ensure the wound form of the magnetic tape MT, obtain a stability in carrying the tape MT, and reduce cost thanks to the improvement of the yield ratio.

In addition, in the winding apparatus W1 where the taper hub H is placed, matching the curvature polarity of the magnetic tape MT, are eliminated possible problems such as an introduction of new equipment for rewinding in a winding apparatus where a taper hub is placed in advance; an equipment investment such as a construction of a trace information system of the magnetic tape MT rewound and the hub polarity, and an increase of labor cost accompanied therewith; an increase of the process; an increase of an intermediate inventory accompanied with the increase of the process; and an increase of the administration cost of the intermediate inventory.

Thus although the fourth embodiment of the present invention is described, the invention is not limited thereto. In the embodiment, although in the rewinding process 18 the pancake PC1 of the plus polarity is made from the pancake PC2 of the minus polarity, the present invention is not limited thereto; for example, rewinding the pancake PC1 of the plus polarity, it is also enabled to obtain the pancake PC2 of the minus polarity. Thus it is enabled to obtain the pancake PC2 of which the polarity is unified in the minus direction.

In addition, although in the embodiment each process is formally described, in a practical process are matched the selection of the pancake PC and the direction of the taper hub H, depending on rewinding times in a following process and a needed curvature polarity.

In the embodiment, although in the polarity determination process 15B is measured the form of the bulk roll BR and is determined the curvature polarity possessed in advance by the magnetic tape MT, the present invention is not limited thereto; for example, measuring the curvature amount Q (see FIGS. 14A and 14B) of the tape MT while from the slitting process 16 to the pancake winding process 17, and based on the measurement result, it is also enabled to determine the curvature polarity of the tape MT. For example, it is assumed that: if the curvature amount Q is the plus, it is the plus curvature; and if the curvature amount Q is the minus, it is the minus curvature.

In the embodiment, although the pancake PC2 of the minus polarity is rewound after the heat treatment process 19, and thereby the pancake PC1 of the plus polarity is obtained; however, in a case that the pancake PC2 of the minus polarity is used as it is, the rewinding process 18 can also be omitted. Depending on a product of a magnetic tape cartridge, in some case the pancake PC2 of the minus polarity is used other than the pancake PC1 of the plus polarity, the rewinding process 18 is not always needed.

### Fifth Embodiment

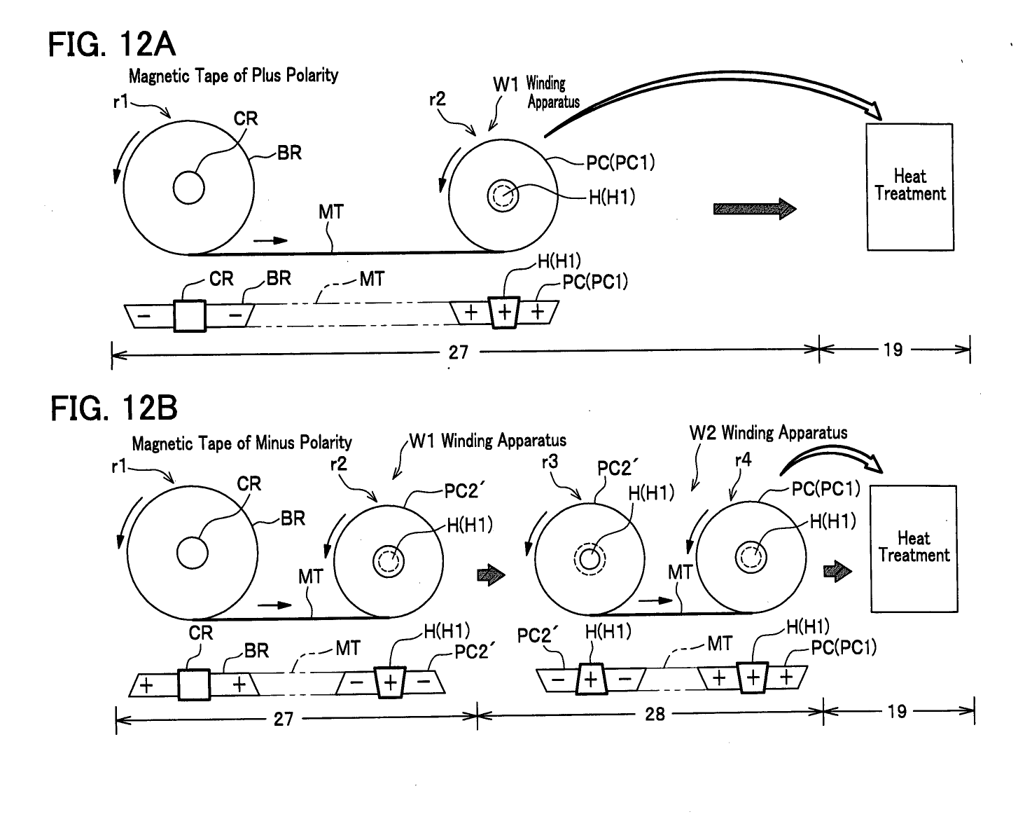

Next will be in detail described a fifth embodiment of a magnetic tape manufacturing method related to the present invention, referring to drawings as needed. FIGS. 12A and 12B are illustration drawings of the pancake winding process 27, the rewinding process 28, and the heat treatment process 19 related to a fifth embodiment; FIG. 12A is a winding process of the magnetic tape MT having the plus polarity; and FIG. 12B is a winding process of the magnetic tape MT having the minus polarity. FIGS. 12A and 12B upper and lower drawings show side views and plan views, respectively.

The magnetic tape manufacturing method related to the fifth embodiment is the manufacturing method of the fourth embodiment where a configuration of the pancake winding process 17, the rewinding process 18, and the heat treatment process 19 (see FIG. 10) after the polarity determination process 15B and the slitting process 16 is changed; Here will be described the pancake winding process 27, the heat treatment process 19, and the rewinding process 28. In addition, in the fifth embodiment, at the take-up reel r2 used in the pancake winding process 27 is attached the taper hub H1 for giving the plus polarity, not depending on the curvature polarity of the magnetic tape MT wound.

Firstly, as a precondition the curvature polarity of the magnetic tape MT wound on the bulk roll BR is determined in the polarity determination process 15B shown in FIG. 10.

Then in the pancake winding process 27 the magnetic tape MT determined as the plus polarity is wound by the winding apparatus W1, as shown in FIG. 12A, where the taper hub H1 for giving the plus curvature polarity is placed, and the pancake PC1 is made. Then the pancake PC1 is moved to the heat treatment process 19 as it is, and a good curvature form is given.

On the other hand, the magnetic tape MT determined as the minus polarity is wound by the winding apparatus W1, as shown in FIG. 12B, where the taper hub H1 for giving the plus curvature polarity is placed, and the pancake PC2′ is made. The pancake PC2′ is made by winding the magnetic tape MT of the minus polarity, and is a pancake where the curvature polarity of the magnetic tape MT and the direction of the taper hub H do not correspond.

Then the pancake PC2′ is placed upside down on the supply reel r3 of the winding apparatus W2 in the rewinding process 28, and is rewound on the taper hub H1 placed at the take-up reel r4. Thus the pancake PC1 of the plus polarity can be made. Then the pancake PC1 is moved to the heat treatment process 19 as it is, and a good curvature form is given.

Thus the following effect can be obtained in the embodiment.

Determining the curvature polarity possessed in advance by the magnetic tape MT, and in the pancake winding process 27, in a case that the polarity of the magnetic tape MT is plus, the tape MT is wound on the taper hub H1 for giving the plus polarity, and after then, is heat-treated. In addition, in a case that the polarity of the magnetic tape MT is minus, the tape MT is wound on the taper hub H1 for giving the plus polarity, after then, again is rewound on the taper hub H1, and is heat-treated. If the curvature polarity possessed in advance by the magnetic tape MT and the direction of the taper hub H do not match, curvature forms at the outer perimeter sides of the pancakes PC1 and PC2′ become unstable; however, in the embodiment, because the tape MT is heat-treated after wound on the taper hub H1 so that the curvature polarity of the tape MT matches that of the taper hub H1, the curvature form of the same plus polarity as the inner perimeter side of the pancake PC1 can be stably given to the outer perimeter side of the pancake PC1.

Thus aligning the curvature form given and reducing a variation thereof, the wound form of the pancake PC1 can be ensured, and stability in carrying the magnetic tape MT can be obtained.

In addition, because the pancake PC2′ where the curvature polarity of the magnetic tape MT and the direction of the taper hub H do not correspond is via the rewinding process 28 where the pancake PC2′ is wound on the taper hub H1, is made the pancake PC1 having the plus polarity, and is heat-treated, a good curvature form can be given to the tape MT.

<Example>

<<Measurement of Curvature Amount at Outer Perimeter Side>

Next will be described an example where the effect of the present invention is confirmed. In the example the curvature amount Q for the curvature polarity of the magnetic tape MT is measured in a case and not a case that the selection of (a direction of) the taper hub H is performed.

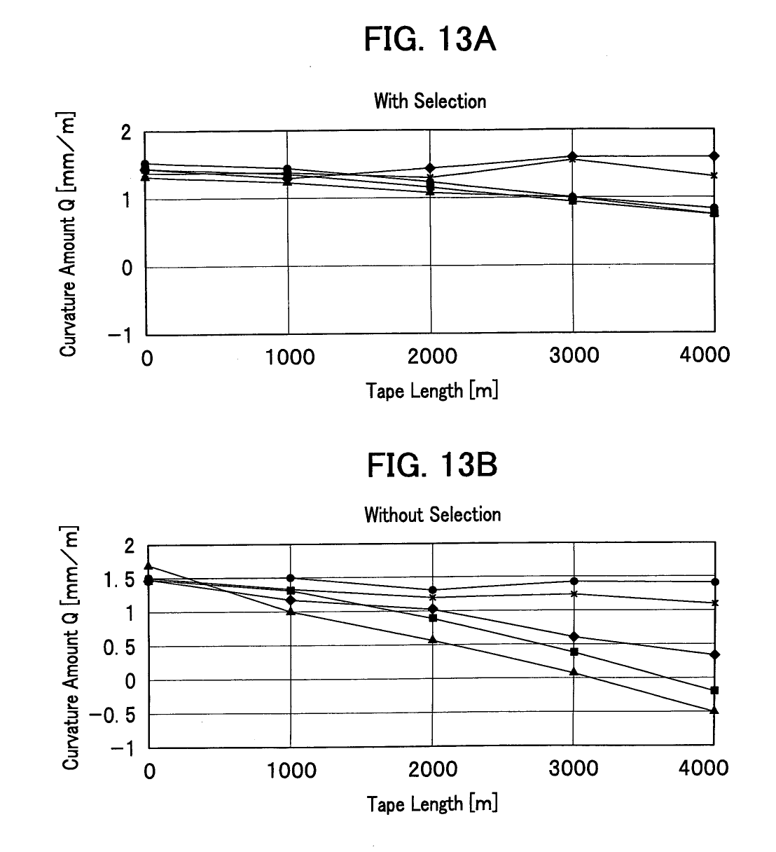

The magnetic tape MT of which a thickness was 9 μm, a length was 4000 mm, and a base film was polyethylene terephthalate (PET) was wound on the taper hub H of which a diameter was 250 mm and a taper amount was 60 μm/18 mm, and was heat-treated at 65 degrees Celsius and 50% humidity for 12 hours. In addition, the curvature polarity (plus polarity) of the magnetic tape was determined by the curvature amount Q (curvature amount at an inner perimeter side) after slitting. Meanwhile, the magnetic tape MT of the minus polarity was once rewound (inserted in a rewinding process). These results are shown in FIGS. 13A and 13B. FIGS. 13A and 13B are graphs showing a curvature amount at each point of a magnetic tape length measured from the inner perimeter side to outer perimeter side of the taper hub H; FIG. 13A is a graph showing a curvature amount in a case that the selection is performed; and FIG. 13B is a graph showing a curvature amount in a case that the selection is not performed.

As shown in FIG. 13A, in the case of performing the selection the curvature amount Q is 1.5 to 1.8 mm/m at the inner perimeter side (0 mm) of the magnetic tape MT; and 1.5 to 1.8 mm/m at the outer perimeter side (4000 mm) thereof. According to the result, it turns out that a stable curvature form is also given to the outer perimeter side.

On the contrary, as shown in FIG. 13B, in the case of not performing the selection the curvature amount Q is 1.5 to 1.8 mm/m at the inner perimeter side (0 mm) of the magnetic tape MT; and −0.5 to 1.5 mm/m at the outer perimeter side (4000 mm) thereof. According to the result, it turns out that a curvature form is fairly varied at the outer perimeter side. Particularly, with respect to the magnetic tape MT of which the curvature amount Q becomes minus, the curvature form becomes opposite at the inner perimeter side and the outer perimeter, and the quality is inferior. It is because the curvature form of the bulk roll BR, where the magnetic tape whole cloth W is wound gives an influence, that the curvature amount Q thus varies at the outer perimeter side.

Thus it turns out that the magnetic tape MT where the curvature polarity of the tape MT is matched with the direction of the taper hub H can obtain a good curvature form and a stable product performance.

### Sixth Embodiment

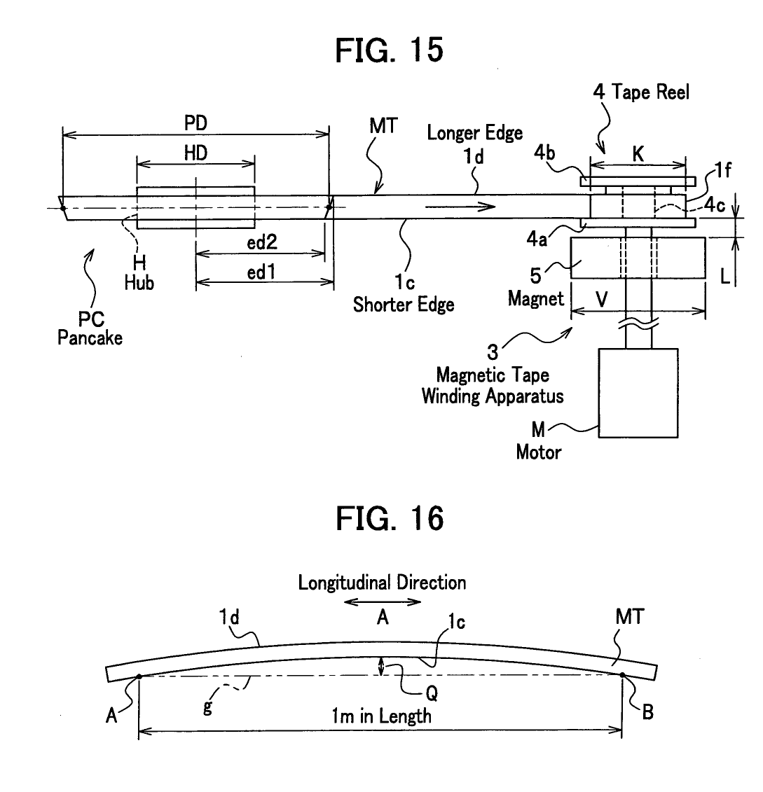

Next will be in detail described a sixth embodiment of a magnetic tape manufacturing method and a magnetic tape winding method related to the present invention, referring to drawings as needed. FIG. 15 is a general drawing showing the magnetic tape winding apparatus 3 related to the sixth embodiment. FIG. 16 is an illustration drawing showing a curvature amount of the magnetic tape MT related to the sixth embodiment. Meanwhile, in the embodiment although the up/down and surface/obverse of the magnetic tape changes according to a direction when disposed, a description is made, for convenience, assuming that upper sides and lower sides in FIGS. 15 and 16 are “up” and “down,” respectively. In addition, in FIGS. 15 and 16 forms of a curvature portion and taper portion of the bulk roll BR, the pancake PC, and the magnetic tape MT are exaggeratedly shown in order to show the portions.

<Manufacturing Method for Magnetic Tape]

The out line of the manufacturing method for the magnetic tape MT used in the magnetic tape winding apparatus 3 is already described, referring to FIG. 1. As shown in FIG. 1, the manufacturing process of the magnetic tape MT of until the bulk roll BR formed from the base film and the magnetic layer is wound by a predetermined amount on the tape reel 4 of a component of a magnetic tape cartridge (not shown) comprises the following steps of: (1) slitting the magnetic tape whole cloth W (bulk roll BR) wound like a barrel into a predetermined width by the slitter 2 and making the magnetic tape MT (slitting process 16); (2) winding the tape MT as the pancake PC so that the curvature polarity of the tape MT becomes one of the plus or minus direction (pancake winding process 17); (3) giving a winding tendency curved in a width direction in a heat treatment process (not shown); (4) and after then, writing a servo signal by the servo writer 8 (servo signal write process 20) and winding the tape MT on the tape reel 4 by the magnetic tape winding apparatus 3 (tape reel winding process 21). Here will be in detail described the magnetic tape winding apparatus 3 and the tape reel winding process 21 comprising features related to the embodiment of the present invention.

<Tape Reel Winding Process>

The magnetic tape MT, which is thus wound as the pancake PC and where the servo signal is written, is wound by a predetermined amount on the tape reel 4 by the dedicated magnetic tape winding apparatus 3 called a tape winder, and is slit.

<<Magnetic Tape Winding Apparatus>>

Next will be described the magnetic tape winding apparatus 3 for winding the magnetic tape MT by a predetermined amount sent out from the pancake PC on a hub 4c of the tape reel 4.

As shown in FIG. 15, the magnetic tape winding apparatus 3 comprises at least: the tape reel 4 where the magnetic tape MT is wound and that has flanges 4a and 4b; a motor M for inserting a motor shaft 4a within the cylindrical hub 4c of the tape reel 4 and rotating the reel 4; a magnet 5 disposed at a shorter edge 1c side of the curved magnetic tape MT wound on the reel 4; and a power source (not shown) for driving the motor M.

<<Magnet>>

The magnet is disposed adjacent to the flange 4a. The magnet 5 winds the magnetic tape MT on the tape reel 4 while effectively attracting the tape MT toward the flange 4a. In the curved magnetic tape MT the shorter edge 1c is disposed at the magnet 5 side. The magnet 5 consists of, for example, a neodymium magnet or an electromagnet that can generate strong magnetism and is like a disc of a diameter V larger than a diameter K of a wound roll if of the magnetic tape MT wound on the tape reel 4. Thus the magnetic tape MT is wound also at the outer perimeter side of the wound roll if while it is being attracted to the magnet 5 side.

In addition, a distance L from the magnet 5 to the wound roll 1f of the magnetic tape MT is preferably 0.5 to 10.0 mm. Meanwhile, in order to attract the magnetic tape MT to the flange 4a at the side where the magnet is disposed by effective magnetism and to wind the tape on the tape reel 4, the nearer the distance L is, the higher the effect is.

<Action of Magnetic Tape Winding Apparatus>

As shown in FIG. 16, in the magnetic tape MT is given a winding tendency of the shorter edge 1c side curving and being shorter. In winding the magnetic tape MT on the tape reel 4 shown in FIG. 15, because the tape MT is wound in a state of a tension at the shorter edge 1c side being higher, it is enabled to wind the tape MT in a state of being neared to the flange 4a side of the magnet 5 side.

Because of this, in winding the magnetic tape MT sent out from the pancake PC by a predetermined amount on the tape reel 4 by the magnetic tape winding apparatus 3, the tape MT results in always being wound on the hub 4c of the tape reel 4 in a predetermined wound form.

Furthermore, in winding the magnetic tape MT, which is sent out from the pancake PC and curved so as to depress in the direction of the shorter edge 1c, by a predetermined amount by the magnetic tape winding apparatus 3, the magnet 5 is disposed adjacent to the flange 4a of the tape reel 4, and the tape MT is wound while it is being attracted to the flange 4a side by magnetism of the magnet 5.

Thus in the magnetic tape winding apparatus 3 (tape reel winding process 21 (see FIG. 1)) the magnetic tape MT is wound so as to always near the flange 4a by elasticity (winding tendency) of the tape MT itself due to the curvature depressed toward the shorter edge 1c side and by magnetism of the magnet 5. As a result, if the magnetic tape MT is wound on the tape reel 4 by the magnetic tape winding apparatus 3, even in a case that the tape reel 4 rotating at higher speed and the tape MT is wound, it becomes enabled for the tape MT to always be wound in a desired wound form, and the winding irregularity of the tape MT is eliminated.

In running the magnetic tape MT thus wound on the tape reel 4, because the tape MT runs in a state of always being neared to the flange 4a of the shorter edge 1c side, for example, it becomes enabled to accurately slide the tape MT on a magnetic head, and thus the running accuracy of the tape MT is improved.

Furthermore, in winding the magnetic tape MT, it is enabled for the magnetic tape apparatus 3 to use the magnet 5 of which the magnetism is comparatively weak by using the elasticity (winding tendency) of the curved magnetic tape MT itself together. Then the magnetic tape MT becomes sufficient without giving a larger curvature if a small curvature exists.

Therefore, when the magnetic tape MT is wound while attracted to the flange 4a side by elasticity (winding tendency) due to the curvature and by magnetism of the magnet 5, because a force by which the edge 1c strikes the flange 4a can be properly made weaker by properly adjusting a force for attracting the tape MT to the edge 1c side with the elasticity and the magnetism, it is eliminated that the edge 1c receives damage.

As a result, for example, even if the magnetic tape MT is not more than 0.3 μm and thin in thickness of the magnetic layer, not less than 1000 GB in memory capacity per one tape reel, and about 400 pieces in track number, it is enabled to prevent a minute projection phenomenon, and a servo error and a drop out due to the projection, and thus the quality of the tape MT can be improved.

Meanwhile, the present invention is not limited to the embodiment, and it goes without saying that various modifications and changes are available within the technical spirit of the invention and the invention covers these.

<Variation Example>

FIG. 17 is a general drawing showing a variation example of the magnetic tape winding apparatus 3 shown in FIG. 15. Meanwhile, with respect to a same configuration as in the embodiment, a same symbol is appended and a description thereof is omitted.

The pancake PC where the magnetic tape MT is wound on the cylindrical hub H as shown in FIG. 15 in the pancake winding process 17 (see FIG. 1) is not limited to being wound on the cylindrical hub H and then heat treated in a heat treatment process.

For example, as shown in FIG. 17, it may also be designed that: the pancake PC3 is wound on the taper hub H3 of which a winding face is formed like a taper, matching the curvature amount Q; a uniform curvature is firmly fixed on each magnetic tape MT in a next heat treatment process (not shown); and a winding tendency thereof is given.

In other words, as shown in the front view of the bulk roll BR of FIG. 1, when the magnetic tape whole cloth W is wound on the winding face of the winding core CR, the curvature polarity and its degree of the outer perimeter of the bulk roll BR are different between the middle portion and left/right end portions of the winding face. Accordingly, the magnetic tape MT obtained by slitting differs in the curvature amount Q according to a slit position thereof. Therefore, it is enabled to make the curvature amount Q of each pancake PC3 constant by winding the magnetic tape MT on the hub H3 of which a winding face is formed like a taper as shown in FIG. 17 and by performing a heat treatment.

The diameter D at the middle portion of the hub H3 of the pancake PC3 is same as the diameter D of the hub H (see FIG. 15) of the pancake PC. Then the ratio of the larger diameter R2 to smaller diameter R1 of the hub H3 is made same as the upper and lower edge ratio RR in Table 1 described before, and is matched with the curvature amount Q of the magnetic tape MT.

In the magnetic tape MT thus wound on the hub H3 like the taper and heat treated, the winding tendency of the magnetic tape whole cloth W given like a wave by a magnetic paint in the bulk roll winding process is regulated to a constant curvature amount Q by the hub H3 like the taper and is uniformed. Therefore, because when the magnetic tape MT is wound on the tape reel 4, a winding tendency of a desired curvature amount Q is always given, the tape MT is wound in a constant state and it is facilitated to adjust the magnetism of the magnet 5 where the tape MT is attracted.

In addition, a treatment of giving a winding tendency that the curvature polarity becomes either one of the plus or minus direction in the magnetic tape MT is not limited to heat-treating the pancake PC wound on the hub H shown in FIG. 1 in the heat treatment process (not shown) and to giving the winding tendency; the treatment is not specifically limited.

For example, it is also available that: in the bulk roll winding process is wound the magnetic tape whole cloth W on the winding face of the winding core CR curvature-formed so as to become a predetermined curvature amount Q; the bulk roll BR is put and heat-treated for a predetermined time in such a constant temperature bath (not shown); and thereby the curvature winding tendency of a desired curvature polarity is given to the whole cloth W.

Thus it is also enabled to give the magnetic tape MT the winding tendency of the edges 1c and id curving in a predetermined direction same as in the embodiment.

### Seventh Embodiment

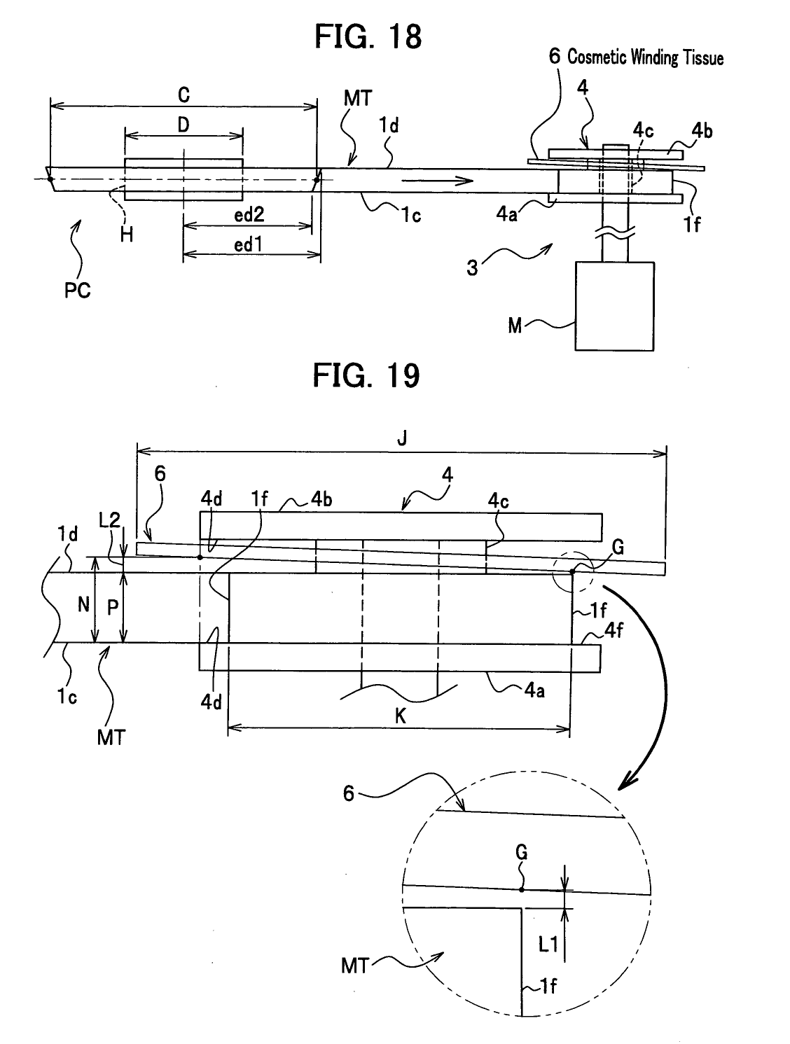

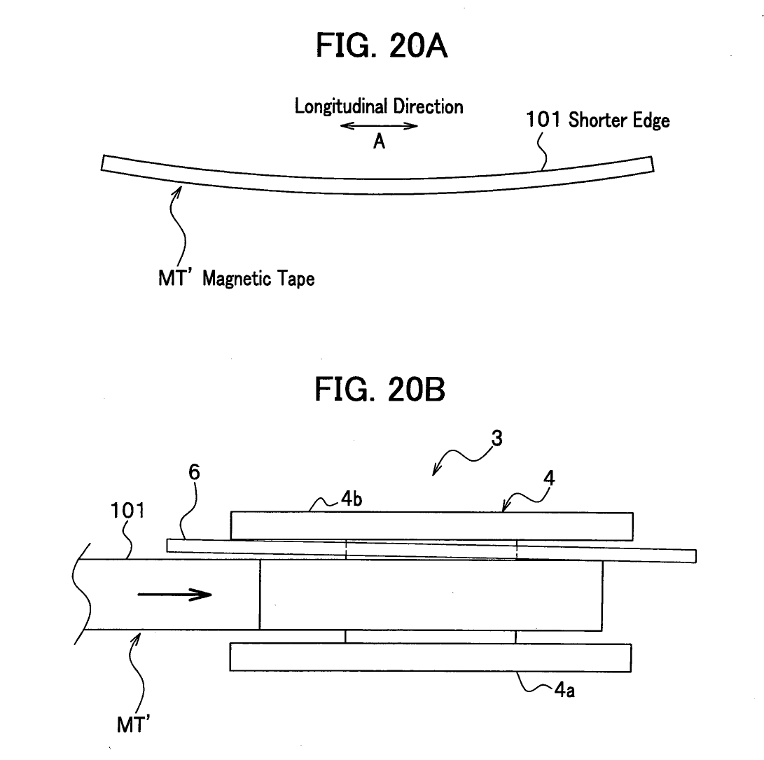

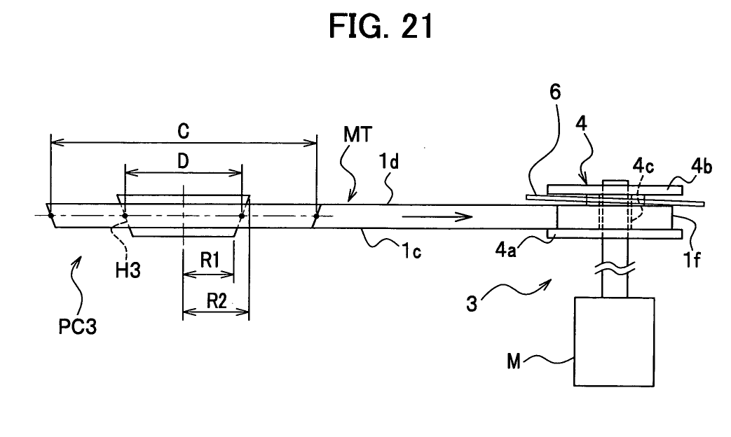

Here will be in detail described a magnetic tape winding apparatus and magnetic tape winding method related to a seventh embodiment of the present invention, referring to drawings as needed. FIG. 18 is a general drawing showing a placement state of the cosmetic winding tissue 6 in the magnetic tape winding apparatus 3 related to the embodiment. FIG. 19 is an enlarged general drawing of a substantial part showing a placement state of the cosmetic winding tissue 6 in the magnetic tape winding apparatus 3 related to the embodiment. FIG. 20A is a general drawing of the magnetic tape MT wound, using the cosmetic winding tissue 6; and FIG. 20B is a general drawing showing a state of the cosmetic winding tissue 6 being disposed at a shorter edge side of the magnetic tape MT, and the tape MT being wound. FIG. 21 is a general drawing showing a variation example of the magnetic tape winding apparatus 3 related to the embodiment. Meanwhile, in the embodiment, although the up/down and surface/obverse of the magnetic tape MT changes according to a direction when disposed, a description is made, for convenience, assuming that upper sides and lower sides in FIGS. 18 to 21 are “up” and “down,” respectively. In addition, in FIGS. 18 to 21 the forms of a curvature portion, slant portion, and taper portion of the bulk roll BR, the pancake PC, the cosmetic winding tissue 6, and the magnetic tape MT are exaggeratedly shown in order to show the portions.

<Manufacturing Method for Magnetic Tape>

The outline of the manufacturing method for the magnetic tape MT used in the magnetic tape winding apparatus 3 is already described, referring to FIG. 1. As shown in FIG. 1, the manufacturing process of the magnetic tape MT of until the bulk roll BR formed from the base film and the magnetic layer is wound by a predetermined amount on the tape reel 4 of a component of a magnetic tape cartridge (not shown) comprises the following steps of: (1) slitting the magnetic tape whole cloth W (bulk roll BR) wound like a barrel into a predetermined width by the slitter 2 and making the magnetic tape MT (slitting process 16); (2) winding the tape MT as the pancake PC so that the curvature polarity of the tape MT becomes one of the plus or minus direction (pancake winding process 17); (3) giving a winding tendency curved in a width direction in a heat treatment process (not shown); (4) and after then, writing a servo signal by the servo writer 8 (servo signal write process 20) and winding the tape MT on the tape reel 4 by the magnetic tape winding apparatus 3 (tape reel winding process 21). Here will be in detail described the magnetic tape winding apparatus 3 and the tape reel winding process 21 comprising features related to the embodiment of the present invention.

<<Magnetic Tape Winding Apparatus>>

Next will be described the magnetic tape winding apparatus 3 for winding the magnetic tape MT by a predetermined amount sent out from the pancake PC on the hub 4c of the tape reel 4.

As shown in FIG. 18, the magnetic tape winding apparatus 3 comprises at least: the tape reel 4 where the magnetic tape MT is wound and that has flanges 4a and 4b; the cosmetic winding tissue 6 disposed at a longer edge side of the tape MT; the motor M for inserting the motor shaft 4a within the cylindrical hub 4c of the tape reel 4 and rotating the reel 4; and a power source (not shown) for driving the motor M.

<<Cosmetic Winding Tissue>>

The cosmetic winding tissue 6 effectively pushes the longer edge id side of the magnetic tape MT to the shorter edge 1c side thereof, and makes the magnetic tape MT wound on the tape reel 4 so as to near the flange 4a. Therefore, the cosmetic winding tissue 6 is disposed at the longer edge id side of the magnetic tape MT on the inner face of the flange 4b. The cosmetic winding tissue 6 consists of, for example, something like a thinner strip freely movably inserted between the flange 4b and the wound roll 1f. The cosmetic winding tissue 6 consists of, for example, any of thinner paper, non-woven cloth, and ultra fine fiber cloth not more than 10 μm in diameter, and comprises the function of removing fine dust.

Meanwhile, as shown in FIG. 19, a width J of the cosmetic winding tissue 6 is formed larger than the outside diameter K of the wound roll If of when the magnetic tape MT is wound on the tape reel 4 by a predetermined amount.

In addition, the cosmetic winding tissue 6 is disposed 0.01 to 0.3 mm separate from the longer edge id of the magnetic tape MT wound on the tape reel 4.

A position where the cosmetic winding tissue 6 regulates the magnetic tape MT wound on the tape reel 4 is given by:

G=P+(0.01 to 0.3 mm),

where the position is G, and the width of the tape MT is P; the tissue 6 is separate from the inside face of the flange 4a by the position G and is built in at the position. In order to prevent a dust accumulation when the magnetic tape MT is wound on the tape reel 4, the cosmetic winding tissue 6 is movably provided in a same direction as the rotation direction of the reel 4.

Furthermore, it is preferable that the cosmetic winding tissue 6 is slantingly disposed for the flanges 4a and 4b and the winding direction of the magnetic tape MT.

In this case, as shown in FIG. 19, the position G where the cosmetic winding tissue 6 regulates the magnetic tape MT wound on the tape reel 4 is adjusted, for example, so as to be a position separate by a distance L1 (for example, about 0.01 mm) from the longer edge id of the tape MT in the vicinity of an exit 4f, and the tissue 6 is built in.

On the other hand, the cosmetic winding tissue 6 is in a state of nearing the flange 4b in the vicinity of an entry 4d at the inside face side of the tape reel 4 and being separate by a distance L2 (for example, about 0.3 mm) from the longer edge id; and is disposed in a state of nearing the edge id in the vicinity of the exit 4f and being separate from the flange 4b.

Thus the cosmetic winding tissue 6 is slanted, thereby a width N at the entry 4d widens for the magnetic tape wound on the tape reel 4, it becomes easy for the tape MT to be wound on the reel 4, and the tape MT is pushed and regulated to the flange 4a side at the exit 4f side.

<Action of Magnetic Tape Winding Apparatus]

As shown in FIG. 16, to the magnetic tape MT is given the winding tendency of the shorter edge 1c side curving and being shorter. In winding the magnetic tape MT on the tape reel 4 shown in FIG. 18, because the tape MT is wound in a state of a tension at the shorter edge 1c side being higher, it is enabled to wind the tape MT in a state of being neared to the flange 4a side.

Because of this, in winding the magnetic tape MT sent out from the pancake PC by a predetermined amount on the tape reel 4 by the magnetic tape winding apparatus 3, the tape MT results in always being wound on the hub 4c of the tape reel 4 in a predetermined wound form.

Furthermore, in winding the magnetic tape MT, which is sent out from the pancake PC and curved so as to depress in the direction of the shorter edge 1c, by a predetermined amount by the magnetic tape winding apparatus 3, the cosmetic winding tissue 6 is disposed at the inside of the flange 4b of the tape reel 4, and the tape MT is wound while it is being pushed to the flange 4a side by the tissue 6.

Thus in the magnetic tape winding apparatus 3 (tape reel winding process 21 (see FIG. 1)) the magnetic tape MT is wound so as to always near the flange 4a by elasticity (winding tendency) of the tape MT itself due to the curvature depressed toward the shorter edge 1c side and by regulation of the cosmetic winding tissue 6. As a result, if the magnetic tape MT is wound on the tape reel 4 by the magnetic tape winding apparatus 3, even in a case that the tape reel 4 rotates at higher speed and the tape MT is wound, it becomes enabled for the tape MT to always be wound in a desired wound form, and thus the winding irregularity of the tape MT is eliminated.

In running the magnetic tape MT thus wound on the tape reel 4, because the tape MT runs in a state of always being neared to the flange 4a of the shorter edge 1c side, for example, it becomes enabled to accurately slide the tape MT on a magnetic head, and thus a running accuracy of the tape MT is improved.

Furthermore, in winding the magnetic tape MT, it is enabled for the magnetic tape apparatus 3 to use the cosmetic winding tissue 6 of which the winding regulation is comparatively weak by using the elasticity (winding tendency) of the curved magnetic tape MT itself together. Then the magnetic tape MT becomes sufficient without a larger curvature being given if a small curvature exists therein.

Therefore, when the magnetic tape MT is wound while neared to the flange 4a side by elasticity (winding tendency) due to the curvature and by regulation of the cosmetic winding tissue 6, because a force by which the edge 1c strikes the flange 4a can be properly made weaker by properly adjusting a force for nearing the tape MT to the edge 1c side with the elasticity and the regulation, it is eliminated that the edge 1c receives damage.

As a result, for example, even if the magnetic tape MT is not more than 0.3 μm in thickness of the magnetic layer, not more than 10 μm in the total thickness and thin, not less than 1000 GB in the memory capacity per one tape reel, and about 400 pieces in track number, it is enabled to prevent a minute projection phenomenon, and a servo error and a drop out due to the projection, and thus the quality of the tape MT can be improved. In addition, because when the magnetic tape MT is stopped or being carried, a movement in a width direction of the longer edge id of the tape MT is regulated by the cosmetic winding tissue 6, the winding irregularity of the tape MT is eliminated even under an environment of a vibration from outside being transmitted.

Next will be described a case that the position of the cosmetic winding tissue 6 is oppositely disposed to the curvature direction of a magnetic tape MT′ as a comparison example for understanding the effect of the present invention. FIG. 20A is a general drawing of a magnetic tape M′ to be wound; and FIG. 20B is a general drawing showing a state of the cosmetic winding tissue 6 being disposed at a shorter edge side 101 of the magnetic tape MT′, and the tape MT′ being wound.

Contrary the magnetic tape MT, in a case that the magnetic tape MT′ curved in an opposite direction as shown in FIG. 20A is wound on the tape reel 4 by the magnetic tape winding apparatus 3 shown in FIG. 20B, because the tape MT′ is wound in a state of a tension being higher at the shorter edge 101 (upper edge), it is wound on the reel 4, nearing the flange 4b side where the cosmetic winding tissue 6 is disposed.

Therefore, the upper edge 101 of the magnetic tape MT′ strongly contacts and abrades the cosmetic winding tissue 6.

Furthermore, in a case that the position of the cosmetic winding tissue 6 is fixed, because the magnetic tape MT′ is wound, nearing the cosmetic winding tissue 6 side of the upper flange 4b side, it strongly contacts and abrades the tissue 6 and edge damage becomes easier to occur.

On the contrary, because the present invention uses the magnetic tape MT curved as shown in FIG. 16, the tape MT wound on the tape reel 4 nears the lower flange 4a side as shown in FIG. 19, the regulation of the upper edge 1d weakens, and thus the tape MT is wound while regulated by an appropriate force. Meanwhile, even in the magnetic tape MT′ curved in the opposite direction shown in FIGS. 20A and 20B it is enabled to make the polarity opposite by once rewinding the tape MT′ on another tape reel.

Meanwhile, the present invention is not limited to the embodiment, and it goes without saying that various modifications and changes are available within the technical spirit of the invention and the invention covers these.

<Variation Example>

FIG. 21 is a general drawing showing a variation example of the magnetic tape winding apparatus 3 related to the seventh embodiment. Meanwhile, with respect to a same configuration as in the seventh embodiment, a same symbol is appended and a description thereof is omitted.

The pancake PC where the magnetic tape MT is wound on the cylindrical hub H as shown in FIG. 15 in the pancake winding process 17 (see FIG. 1) is not limited to being wound on the cylindrical hub 4c and heat treated in a heat treatment process.

For example, as shown in FIG. 21, it may also be designed that: the pancake PC3 is wound on the taper hub H3 of which a winding face is formed like a taper, matching the curvature amount Q; a uniform curvature is firmly fixed on each magnetic tape MT in a next heat treatment process (not shown); and a winding tendency thereof is given.

In other words, as shown in the front view of the bulk roll BR of FIG. 1, when the magnetic tape whole cloth W is wound on the winding face of the winding core CR, the curvature polarity and its degree of the outer perimeter of the bulk roll BR are different between the middle portion and left/right end portions of the winding face. Accordingly, the magnetic tape MT obtained by slitting differs in the curvature amount Q according to a slit position thereof. Therefore, it is enabled to make the curvature amount Q of each pancake PC3 constant by winding the magnetic tape MT on the hub H3 of which the winding face as shown in FIG. 8 is formed like a taper and by performing a heat treatment.

The diameter D at the middle portion of the hub H3 of the pancake PC3 is same as the diameter D of the hub H (see FIG. 15) of the pancake PC. Then the ratio of the larger diameter R2 to smaller diameter R1 of the hub H3 is made same as the upper and lower edge ratio RR in Table 1 described before, and is matched with the curvature amount Q of the magnetic tape MT.

In the magnetic tape MT thus wound on the hub H3 like a taper and heat treated, the winding tendency of the magnetic tape whole cloth W given like a wave by a magnetic paint in the bulk roll winding process is regulated to the constant curvature amount Q by the hub H3 like a taper and is uniformed. Therefore, because when the magnetic tape MT is wound on the tape reel 4, the winding tendency of a desired curvature amount Q is always given, the tape MT is wound in a constant state and it is facilitated to adjust the cosmetic winding tissue 6 where the tape MT is regulated.

In addition, a treatment of giving a winding tendency that the curvature polarity becomes either one of the plus or minus direction in the magnetic tape MT is not limited to heat-treating the pancake PC wound on the hub H shown in FIG. 1 in the heat treatment process (not shown) and to giving the winding tendency; the treatment is not specifically limited.

For example, it is also available that: in the bulk roll winding process is wound the magnetic tape whole cloth W on the winding face of the winding core CR formed so as to become a predetermined curvature amount Q; the bulk roll BR is put and heat-treated for a predetermined time in such a constant temperature bath (not shown); and thereby the curvature winding tendency of a desired curvature polarity is given to the whole cloth W.

Thus it is also enabled to give the magnetic tape MT the winding tendency of the edges 1c and id curving in a predetermined direction same as in the embodiment.

What is claimed is:

1. A manufacturing method for a magnetic tape curved in a width direction,
the method comprising:
a determination process of determining a curvature polarity possessed in advance by said magnetic tape; and
a winding process of winding said magnetic tape on a taper hub comprising a taper winding face corresponding to the curvature polarity of said magnetic tape.

2. The manufacturing method according to claim 1 further comprising;
a bulk roll placement process of placing a bulk roll at a supply reel side of a winding apparatus in advance of said determination process; and
a slitting process of slitting a magnetic tape whole cloth sent out from said bulk roll into a plurality of predetermined width tapes,
wherein said winding process places said taper hub at a take-up reel side of said winding apparatus in a direction corresponding to the curvature polarity of said magnetic tape, and winds a slit magnetic tape sent out from said bulk roll on said taper hub.

3. The manufacturing method according to claim 1 further comprising;
a bulk roll placement process of placing a bulk roll at a supply reel side of a winding apparatus in advance of said determination process; and
a slitting process of slitting a magnetic tape whole cloth sent out from said bulk roll into a plurality of predetermined width tapes,
wherein said determination process determines the curvature polarity of said magnetic tape, based on a form of said bulk roll.

4. The manufacturing method according to claim 3 further comprising a winding process of winding a slit magnetic tape sent out from said bulk roll on a hub comprising a flat winding face in advance of said winding process.

5. The manufacturing method according to claim 3, wherein said determination process measures a form of said bulk roll and determines a curvature polarity of each slit magnetic tape from a slit position, which makes a width direction end of said bulk roll a standard, and a taper amount at an outer perimeter of said bulk roll at the slit position.

6. The manufacturing method according to claim 1, wherein said determination process measures a curvature amount in a width direction between two arbitrary points of a longitudinal direction of said magnetic tape and determines the curvature polarity of said magnetic tape.

7. The manufacturing method according to claim 1 further comprising a rewinding process of rewinding a magnetic tape, which is determined to have either one of a plus or minus curvature polarity in said determination process, on a taper hub of an opposite polarity to said taper hub after said winding process.

8. The manufacturing method according to claim 1 further comprising a heat treatment process of keeping and heat-treating said magnetic tape wound in said winding process for a predetermined time under a predetermined environment temperature.

9. The manufacturing method according to claim 7 further comprising a heat treatment process of keeping and heat-treating said magnetic tape rewound in said rewinding process for a predetermined time under a predetermined environment temperature.

10. The manufacturing method according to claim 1, wherein said taper hub comprises a fit-in hole for engaging in a rotation engagement stopper pin provided at a winding shaft for rotating the taper hub, and wherein said fit-in hole opens to only one side face.

11. The magnetic tape manufactured according to the manufacturing method of claim 1 and comprising a curvature amount of 0.5 to 4.0 mm/m.

12. The magnetic tape manufactured according to the manufacturing method of claim 1 and comprising a curvature amount of −4.0 to −0.5 mm/m.

13. The manufacturing method according to claim 1 further comprising a reel up process of a tape reel having a flange and a magnet adjacent to said flange disposing said tape reel, said magnet, and said magnetic tape so that a shorter edge of the magnetic tape curved in said width direction is positioned at a flange side of said tape reel; and winding said magnetic tape on said tape reel, wherein a reel of the magnetic tape is made.

14. The manufacturing method according to claim 1 further comprising a reel up process of disposing a cosmetic winding tissue at a longer edge side of the magnetic tape curved in said width direction and winding said magnetic tape on said tape reel, wherein a reel of the magnetic tape is made.

15. A magnetic tape manufacturing method for winding a magnetic tape obtained by being slit from a bulk roll on a taper hub having a taper winding face, the method comprising:
a bulk roll placement process of placing said bulk roll at a supply reel side of a winding apparatus;
a determination process of determining a curvature polarity possessed in advance by said magnetic tape;
a hub placement process of placing said taper hub at a take-up reel side of said winding apparatus in a direction corresponding to either one of said minus or plus curvature polarity; and
a winding process of winding said magnetic tape sent out from said bulk roll on said taper hub,
wherein when placing said taper hub in a direction corresponding to the curvature polarity of said magnetic tape according to a determination result in said determination process, the magnetic tape wound on said taper hub in said winding process is kept and heat-treated for a predetermined time under a predetermined environment temperature, and
wherein when placing said taper hub in a direction not corresponding to the curvature polarity of said magnetic tape according to the determination result in said determination process, the magnetic tape is wound on said taper hub corresponding to the curvature polarity of said magnetic tape, and after then, is kept and heat-treated for a predetermined time under a predetermined environment temperature.

16. The manufacturing method according to claim 15, wherein said cosmetic winding tissue is slantingly disposed for a winding direction of said magnetic tape.

17. A magnetic tape winding method comprising the steps of: disposing a tape reel, a magnet, and a magnetic tape so that a shorter edge of said magnetic tape curved in a width direction is positioned at a flange side of said tape reel in the tape reel having a flange and said magnet adjacent to said flange; and winding said magnetic tape on said tape reel.

18. A magnetic tape winding method comprising the steps of: disposing a cosmetic winding tissue on an inside face of a flange of a tape reel disposed at a longer edge side of the magnetic tape curved in a width direction; and winding said magnetic tape on said tape reel.

19. A magnetic tape winding apparatus for winding a magnetic tape curved in a width direction on a tape reel having a flange, wherein on an inside face of said flange a cosmetic winding tissue is disposed at a longer edge side of said curved magnetic tape.

20. A magnetic tape winding apparatus for disposing a magnet adjacent to a flange of a tape reel in winding a magnetic tape curved in a width direction, and for winding said magnetic tape, wherein said magnet is disposed at a shorter edge side of said curved magnetic tape.
